(19) United States
(12) Patent Application Publication
(10) Pub. No.: US 2010/0232598 A1
(43) Pub. Date: Sep. 16, 2010

(54) INFORMATION RECORDING MEDIUM, INFORMATION RECORDING APPARATUS AND METHOD, AND COMPUTER PROGRAM

(75) Inventor: Takao Sawabe, Saitama (JP)

Correspondence Address: YOUNG & THOMPSON, 209 Madison Street, Suite 500, Alexandria, VA, 22314, US

(73) Assignee: Pioneer Corporation, Tokyo (JP)

(21) Appl. No.: 12/294,486

(22) PCT Filed: Mar. 27, 2007
(86) PCT No.: PCT/JP2007/056484

§ 371 Date: Sep. 25, 2008

(30) Foreign Application Priority Data
Mar. 31, 2006 (JP) 2006-098890

(51) Int. Cl. H04N 5/91; H04L 9/28

(52) U.S. Cl. 380/28; 386/95

(57) ABSTRACT

An information recording medium (10, 301) is provided with: a content recording area to record therein a content group (20) including title information (30); and a control information recording area to record therein control information (37, 38) including (i) type information (412) indicating whether or not the content group is authorized as an image file based on a predetermined format, and (ii) structure information (413) indicating whether or not the content group includes management information (40) for managing the content group.

### TECHNICAL FIELD

The present invention relates to an information recording medium, such as a DVD (Digital Versatile Disc), an information recording apparatus and method, such as a DVD recorder, and a computer-readable recording medium recording thereon a computer program which makes a computer function as such an information recording apparatus.

### BACKGROUND ART

The DVD-Video standard is complied with, in the case where video information compression-coded by MPEG (Moving Picture Expert Group) 1 or MPEG 2, which are one example of compression-coding, is recorded onto an optical disc, such as a DVD. According to the DVD-Video standard, the compression-coding and high-density recording of the record data has advanced to the extent that content information with a volume of about one movie can be recorded onto one optical disc. The DVD-Video standard is standardized mainly to prepare packaged software including the title of a movie or the like, and to sell the packaged software to users. On the other hand, since the DVD-Video standard is standardized mainly to record the read-only title, a users' arbitrary editing is restricted. In particular, the DVD-Video standard is not suited for such an application that users record the title, such as a TV program, in which commercial messages (CM) and a main story are discretely arranged, while editing the CM. In addition, in the DVD-Video standard, the copy-once title broadcasted in terrestrial digital broadcasting and BS digital broadcasting cannot be recorded.

That is why the DVD-VR (Video Recoding) standard, disclosed in a patent document 1, is standardized in addition to the DVD-Video standard. In the DVD-VR standard, users can record the title, such as a TV program, in which CM and a main story are discretely arranged, while editing the CM, or users can edit it after recording the title. In addition, the DVD-VR standard supports CPRM (Contents Protection for Recordable Media) or the like, so that the copy-once title can be recorded. Thus, it is possible to preferably protect the copyright of the title to be recorded.

Patent document 1: Japanese Patent Application Laid Open NO. 2003-317395

### DISCLOSURE OF INVENTION

### Subject to be Solved by the Invention

On the other hand, a development of a distribution system in which the title, such as a movie, is stored on a server on the Internet, the title is distributed to users and the users record the distributed title onto optical discs is desired. In particular, the distributed title tends to be a movie or the like that users do not have to edit. Thus, a development of a distribution system, in which the title to be distributed is stored on the server in accordance with the DVD-Video standard and the title in accordance with the DVD-Video standard is distributed, is desired.

However, because there can be a plurality of servers, there is such a technical problem that it is hard or impossible to recognize which server has the title that a user desires and what kind of files constitute the title. In other words, even if the title can be stored on the server, there is still such a technical problem that the user who will download the title (or recorder owned by the user) can hardly recognize or cannot recognize which file is to be downloaded and is to be recorded in what kind of aspect, in order to record the desired title in accordance with the DVD-Video standard onto the optical disc.

It is therefore an object of the present invention to provide an information recording medium, an information recording apparatus and method, which are operable to preferably record the desired title, and a computer program which makes a computer function as such an information recording apparatus.

### Means for Solving the Subject

(Information Recording Medium)

The above object of the present invention can be achieved by an information recording medium, provided with: a content recording area to record therein a content group including one or a plurality of title information (e.g. VTS described later); and a control information recording area to record therein control information including (i) type information (e.g. file data type information described later) indicating whether or not the content group is authorized as an image file based on a predetermined format (e.g. DVD-Video standard descried later), and (ii) structure information (e.g. file data structure information described later) indicating whether or not the content group includes management information (e.g. VMG described later) for managing the content group, in addition to the one or plurality of title information.

According to the information recording medium of the present invention, the content group including the title information, such as, for example, a movie and a TV program, is recorded into the content recording area. The content group may include one or a plurality of title information.

Particularly in the present invention, the control information for managing the content group is recorded into the control information recording area. The control information includes the type information and the structure information. The type information indicates whether or not the content group is authorized as the image file based on the predetermined format. The structure information indicates whether or not the content group is authorized as the image file, with the content group including the management information for managing the content group in addition to the one or plurality of title information.

By this, with reference to the control information, it can be relatively easily recognized whether or not the content group is authorized as the image file, and furthermore, whether or not the content group is authorized as the image file including the management information. Therefore, for example, when an information recording apparatus described later obtains (in other words, downloads) the content group recorded on the information recording medium of the present invention, which is connected to the information recording apparatus via a network, it can be relatively easily judged whether or not the information recording apparatus can perform a finalize process without a special process (or immediately after recording the content group), after recording the content group onto an information recording medium loaded on the information recording apparatus, by referring to the control information.

In addition, if the information recording apparatus records the content group in the same data structure as that of the information recording medium of the present invention, it can be also relatively easily judged whether or not the desired content group is accurately obtained and recorded, by comparing it with the information recording medium that is a source to obtain the content group.

Moreover, the control information is enough to be referred when the content group is recorded, so that the control information has no or little special adverse effect when the recorded content group is reproduced.

In one aspect of the information recording medium of the present invention, the control information includes title number information (e.g. information as for the number of VTSs, described later) indicating the total number of the title information included in the content group.

According to this aspect, with reference to the control information, the total number of the title information included in the content group can be relatively easily recognized.

Moreover, for example, the information recording apparatus described later can obtain and record, without omission, the one or plurality of title information which is necessary to obtain and record the desired content group. As a result, the desired content group can be preferably recorded.

In another aspect of the information recording medium of the present invention, the control information includes title file number information (e.g. information as for the number of files in VTS#1, described later) indicating the total number of files included in each of the one or plurality of title information.

According to this aspect, with reference to the control information, the total number of the files included in the title information can be relatively easily recognized. If the content group includes a plurality of title information, the control information preferably includes a plurality of file number information corresponding to the respective plurality of title information. Each of the plurality of file number information preferably indicates the total number of the files included in the corresponding title information.

Moreover, for example, the information recording apparatus described later can obtain and record, without omission, the one or plurality of files necessary to obtain and record the one or plurality of title information. As a result, the desired content group can be preferably recorded.

In another aspect of the information recording medium of the present invention, the control information includes an identifier (e.g. file ID#1 information, etc.) for identifying the content group.

According to this aspect, with reference to the control information, the content group can be relatively easily identified.

Moreover, for example, the information recording apparatus described later can identify the content group by using the identifier, to thereby obtain and record the desired content group.

In an aspect of the information recording medium in which the control information includes the identifier, as described above, the control information may include code information (e.g. character code information, described later) indicating a character code of the identifier.

By virtue of such construction, with reference to the control information, the identifier can be preferably recognized.

Moreover, for example, the information recording apparatus described later can preferably recognize the identifier by using the code information, to thereby identify the desired content group by using the identifier.

In another aspect of the information recording medium of the present invention, the control information includes management file number information (e.g. information as for the number of files in VMG, described later) indicating the total number of files included in the management information.

According to this aspect, with reference to the control information, the total number of the files included in the management information can be relatively easily recognized.

Moreover, for example, the information recording apparatus described later can obtain and record, without omission, the one or plurality of files necessary to obtain and record the management information. As a result, the desired content group can be preferably recorded.

In another aspect of the information recording medium of the present invention, the control information includes menu preparation information (e.g. VMGM-generation auxiliary data preparation information, described later) indicating whether or not the content group includes menu generation information, which is to generate general menu information as for the entire content group (e.g. a menu having a function of selecting the desired title information from among the plurality of title information included in the content group and instructing the reproduction of the desired title information selected, etc.), in addition to the one or plurality of title information.

According to this aspect, with reference to the control information, it can be relatively easily recognized whether or not the desired content group includes the menu generation information.

If the desired content group includes the menu generation information, for example, the information recording apparatus described later can generate the general menu information as for the entire content group, by using the menu generation information.

In another aspect of the information recording medium of the present invention, the control information includes a general menu flag (e.g. VMGM preparation flag, described later) indicating whether or not the content group includes general menu information as for the entire content group, in addition to the one or plurality of title information.

According to this aspect, with reference to the control information, it can be relatively easily recognized whether or not the content group includes the general menu information as for the entire content group.

Moreover, if the content group includes the general menu information, the information recording apparatus described later can obtain the general menu information without omission.

In another aspect of the information recording medium of the present invention, the control information includes a title menu flag (e.g. VTSM preparation flag, described later) indicating whether or not the content group includes title menu information as for at least one of the one or plurality of title information, in addition to the one or plurality of title information.

According to this aspect, with reference to the control information, it can be relatively easily recognized whether or not the desired content group includes the title menu information.

Moreover, if the content group includes the desired title menu information, the information recording apparatus described later can obtain the title menu information without omission.

Incidentally, the “title menu” in the present invention means a menu or the like having a function of setting reproduction conditions (e.g. selecting an audio language in the reproduction, or selecting a sub-picture language (e.g. subtitle language) in the reproduction) with respect to one title information selected by using the general menu. This title menu is distinguished from above-mentioned “general menu”. Incidentally, if the “title menu” is expressed by a term more faithful to its function, the “title menu” can be referred to as a “title reproduction state selecting menu (or title reproduction condition selecting menu)”. In the present invention, however, it is referred to as the “title menu” to give the explanation.

In another aspect of the information recording medium of the present invention, the control information includes encryption information (e.g. CPS Status information, described later) indicating whether or not the content group is encrypted.

According to this aspect, with reference to the control information, it can be relatively easily recognized whether or not the desired content group is encrypted.

Moreover, if the desired content group is encrypted, the information recording apparatus described later records the obtained content group as it is. On the other hand, if the desired content group is not encrypted, the information recording apparatus records the obtained content group after encrypting it.

In an aspect of the information recording medium in which the control information includes the encryption information, as described later, the control information may include encryption system information (e.g. applied CPS information, described later) indicating an encryption system of the content group.

By virtue of such construction, with reference to the control information, the encryption system of the content group can be recognized, relatively easily.

Moreover, for example, the information recording apparatus described later can encrypt the desired content group, by using the recognized encryption system.

In another aspect of the information recording medium of the present invention, the information recording medium is provided with a plurality of control information recording areas.

According to this aspect, if the control information is effectively recorded in at least one of the plurality of control information recording areas, the control information can be preferably referred to.

Moreover, for example, the information recording apparatus described later can preferably obtain and record the desired content group, by obtaining the control information from at least one of the plurality of control information recording areas.

In another aspect of the information recording medium of the present invention, the control information recording area is disposed in the content recording area.

According to this aspect, the control information is recorded as one portion of the content group.

(Information Recording Apparatus)

The above object of the present invention can be also achieved by an information recording apparatus for recording a content group onto a second information recording medium from a first information recording medium (i.e. the above-mentioned information recording medium of the present invention) recording thereon: the content group including one or a plurality of title information; and control information including (i) type information indicating whether or not the content group is authorized as an image file based on a predetermined format, and (ii) structure information indicating whether or not the content group includes management information for managing the content group, in addition to the one or plurality of title information, the information recording apparatus provided with: a first obtaining device for obtaining the control information recorded on the first information recording medium; a second obtaining device for obtaining the content group from the first information recording medium, on the basis of the obtained control information; and a recording device for recording the obtained content group onto the second information recording medium.

According to the information recording apparatus of the present invention, by the virtue of the operation of the first obtaining device, the control information recorded on the first information recording medium is obtained. Then, by virtue of the operation of the second obtaining device, the content group which is recorded on the first recording medium and which the user desires is obtained on the basis of the obtained control information. After that, by virtue of the operation of the recording device, the obtained content group is recorded onto the second information recording medium. Namely, the desired content group is recorded onto the second information recording medium.

In particular, the information recording apparatus of the present invention can relatively easily recognize whether or not the content group is authorized as the image file, and furthermore, whether or not the content group is authorized as the image file including the management information, with reference to the control information, as in the above-mentioned information recording medium of the present invention. Therefore, for example, in obtaining the content group recorded on the first information recording medium connected to the information recording apparatus via the network, it can be relatively easily judged whether or not the information recording apparatus can perform a finalize process without a special process (or immediately after recording the content group), after recording the content group onto the second information recording medium, by referring to the control information.

Moreover, the control information is enough to be referred when the content group is recorded onto the second information recording medium, so that the control information has no or little special adverse effect when the recorded content group is reproduced.

Incidentally, the first information recording medium on which the content group and the control information are recorded in advance, and the second information recording medium onto which the content group and the control information are recorded by the operation of the information recording apparatus, are obviously included in the scope of the above-mentioned information recording medium of the present invention.

In one aspect of the information recording apparatus of the present invention, the recording device records the obtained control information onto the second information recording medium.

According to this aspect, by comparing the first information recording medium (particularly, the control information recorded on the first information recording medium) with the second information recording medium (particularly, the control information recorded on the second information recording medium), it can be relatively easily judged whether or not the desired content group is accurately obtained and recorded.

In another aspect of the information recording apparatus of the present invention, the control information includes title number information indicating the total number of the title information included in the content group, and title file number information indicating the total number of files included in each of the one or plurality of title information, and the second obtaining device obtains the predetermined number of files corresponding to the title number information and the title file number information, as the content group.

According to this aspect, it is possible to obtain and record, without omission, the one or plurality of title information necessary to obtain and record the desired content group, and furthermore, the one or plurality of files necessary to obtain and record the one or plurality of title information. As a result, the desired content group can be preferably recorded.

In another aspect of the information recording apparatus of the present invention, the control information includes an identifier for identifying the content group, and the second obtaining device obtains the content group identified by the identifier.

According to this aspect, by identifying the content group by using the identifier, the desired content group can be obtained and recorded.

In another aspect of the information recording apparatus of the present invention, the control information includes management file number information indicating the total number of files included in the management information, and the second obtaining device obtains the predetermined number of files corresponding to the management file number information, as the content group.

According to this aspect, it is possible to obtain and record, without omission, the one or plurality of files necessary to obtain and record the management information. As a result, the desired content group can be preferably recorded.

In another aspect of the information recording apparatus of the present invention, it is further provided with a finalizing device for performing a finalize process on the second information recording medium after the recording of the content group by the recording device, if the content group is authorized as the image file and the content group includes the management information.

According to this aspect, after recording the content group onto the second recording medium, it is possible to perform the finalize process without a special process (or immediately after recording the content group).

In another aspect of the information recording apparatus of the present invention, it is further provided with: a generating device for generating the management information corresponding to the obtained content group after the recording of the content group by the recording device, if the content group does not include the management information; and a finalizing device for performing a finalize process on the second information recording medium after the management information is generated.

According to this aspect, if the content group does not include the management information, the information recording apparatus can generate the management information. After generating the management information, information recording apparatus can record the management information onto the second information recording medium and perform the finalize process.

In another aspect of the information recording apparatus of the present invention, the recording device records the obtained control information into a plurality of positions on the second information recording medium.

According to this aspect, if the control information is effectively recorded in at least one of the plurality of control information recording areas, the control information can be preferably referred to.

Incidentally, the second information recording medium on which the content group and the control information are recorded by the operation of the recording device is apparently included in the scope of the above-mentioned information recording medium of the present invention.

(Information Recording Method)

The above object of the present invention can be also achieved by an information recording method of recording a content group onto a second information recording medium from a first information recording medium recording thereon: the content group including one or a plurality of title information; and control information including (i) type information indicating whether or not the content group is authorized as an image file based on a predetermined format, and (ii) structure information indicating whether or not the content group includes management information for managing the content group, in addition to the one or plurality of title information, the information recording method provided with: a first obtaining process of obtaining the control information recorded on the first information recording medium; a second obtaining process of obtaining the content group from the first information recording medium, on the basis of the obtained control information; and a recording process of recording the obtained content group onto the second information recording medium.

According to the information recording method of the present invention, it is possible to receive the same various benefits as those of the above-mentioned information recording apparatus of the present invention.

Incidentally, in response to the various aspects of the information recording apparatus of the present invention described above, the information recording method of the present invention can adopt various aspects.

(Computer Program)

The above object of the present invention can be also achieved by a computer program for recording control to control a computer provided in the above-mentioned information recording apparatus of the present invention (incidentally, including its various aspects), to make the computer function as at least one of the first obtaining device, the second obtaining device, and the recording device.

According to the computer program of the present invention, the above-mentioned information recording apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the information recording apparatus of the present invention described above, the computer program of the present invention can adopt various aspects.

The above object of the present invention can be also achieved by a computer program product in a computer-readable medium for tangibly embodying a program of instructions executable by a computer provided in above-mentioned information recording apparatus of the present invention (incidentally, including its various aspects), to make the computer function as at least one of the first obtaining device, the second obtaining device, and the recording device

According to the computer program product of the present invention, the aforementioned information recording apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned information recording apparatus of the present invention.

These effects and other advantages of the present invention will become more apparent from the embodiment explained below.

As explained above, according to the information recording medium of the present invention, it is provided with the content recording area and the control information recording area. According to the information recording apparatus of the present invention, it is provided with the first obtaining device, the second obtaining device, and the recording device. According to the information recording method of the present invention, it is provided with the first obtaining process, the second obtaining process, and the recording process. According to the computer readable recording medium recording thereon the computer program of the present invention, it makes a computer function as at least one portion of the first obtaining device, the second obtaining device, and the recording device. Therefore, the desired title can be preferably recorded.

### BRIEF DESCRIPTION OF DRAWINGS

FIG. 1 is a block diagram conceptually showing the basic structure of a recording system in an embodiment;

FIG. 2 is a block diagram conceptually showing the basic structure of an information recording apparatus constituting the recording system in the embodiment;

FIG. 3 are data structure diagrams conceptually showing the data structures of content groups;

FIG. 4 is a data structure diagram conceptually showing the data structure of VTS constituting the content group;

FIG. 5 is a data structure diagram conceptually showing the data structure of VMG constituting the content group;

FIG. 6 is a data structure diagram conceptually showing the data structure of first control information included in the VTS and the VMG constituting the content group;

FIG. 7 is a data structure diagram conceptually showing the data structure of second control information included in the VTS and the VMG constituting the content group;

FIG. 8 is a data structure diagram conceptually showing the data structure of additional information constituting the first control information;

FIG. 9 is a data structure diagram conceptually showing a specific first data structure of the first control information and the second control information in the specific content group using the data structures explained in FIG. 3 to FIG. 8;

FIG. 10 is a data structure diagram conceptually showing a specific second data structure of the first control information and the second control information in the specific content group using the data structures explained in FIG. 3 to FIG. 8;

FIG. 11 is a data structure diagram conceptually showing a specific third data structure of the first control information and the second control information in the specific content group using the data structures explained in FIG. 3 to FIG. 8;

FIG. 12 is a flowchart conceptually showing a first flow of the recording operation of the recording system in the embodiment;

FIG. 13 is a flowchart conceptually showing a second flow of the recording operation of the recording system in the embodiment;

FIG. 14 is a flowchart conceptually showing a third flow of the recording operation of the recording system in the embodiment;

FIG. 15 is a flowchart conceptually showing a fourth flow of the recording operation of the recording system in the embodiment; and

FIG. 16 is an explanatory diagram conceptually showing the area structure of an optical disc on which the content group is recorded.

### DESCRIPTION OF REFERENCE CODES

10 optical disc
20 content group
30 VTS
31 VTSI
32 VTSM_VOBS
33 VTS_VOBS
34 VTSI_BUPS
35 VTS_MAT
37 first control information
38 second control information
40 VMG
41 VMGI
42 VMGM_VOBS
44 VMGI_BUPS
45 VTS_MAT
100 information recording apparatus
200 communication network
300 distribution server
301 hard disk
112 optical pickup
113 signal recording device
121 CPU
128 control information obtainment/analysis device
129 file obtainment device
401 application system type information
402 applied CPS (Contents Protection System) information
403 CPS Status information
412 file data type information
413 file data structure information
414 additional information
415 information as for the number of VTSs
416 information as for the number of files in VMG
417 character code information
418 to 426 information as for the number of files in VTS
427 file ID information
4141 VMGM preparation flag
4142 VTSM preparation flag
4143 VMGM-generation auxiliary data preparation information

### BEST MODE FOR CARRYING OUT THE INVENTION

Hereinafter, the embodiment of the present invention will be explained with reference to the drawings.

(1) Basic Structure

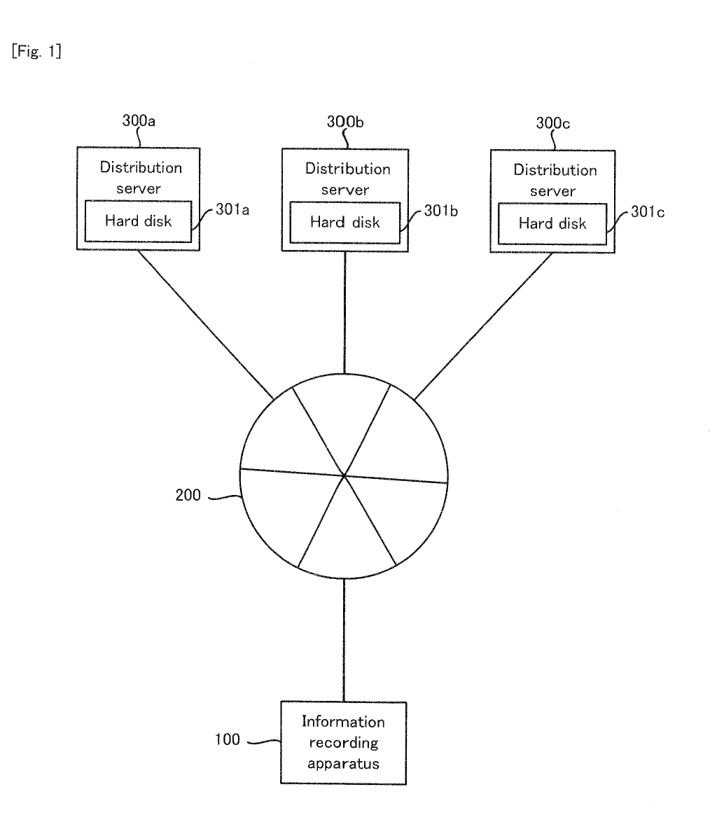

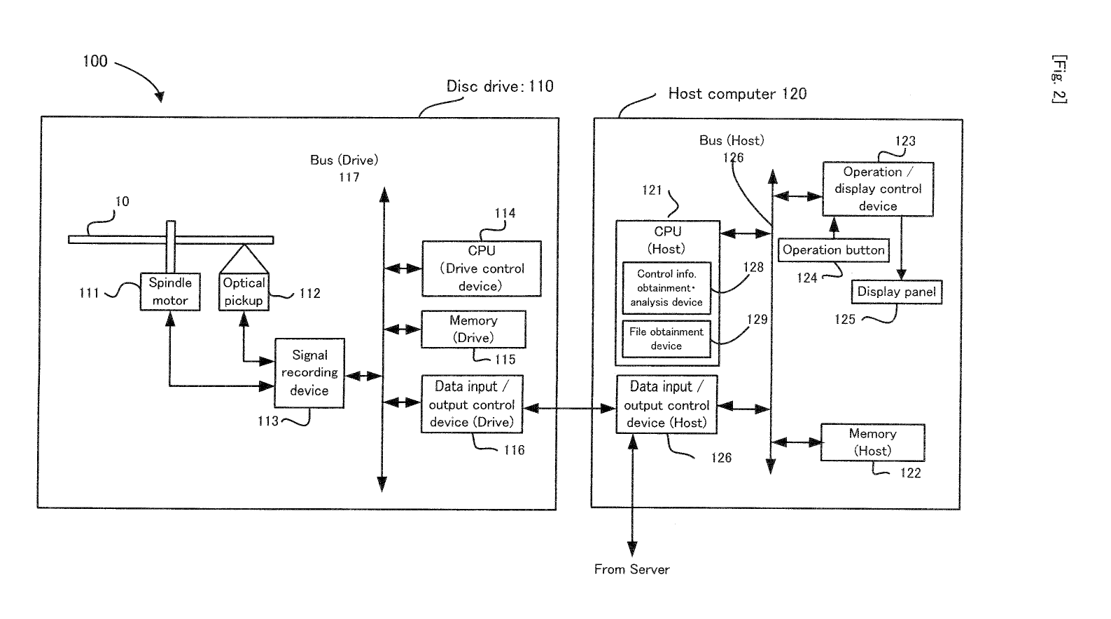

Firstly, with reference to FIG. 1 and FIG. 2, the basic structure of a recording system 1 in this embodiment will be explained. FIG. 1 is a block diagram conceptually showing the basic structure of the recording system 1 in the embodiment. FIG. 2 is a block diagram conceptually showing the basic structure of an information recording apparatus 100 constituting the recording system 1 in the embodiment.

As shown in FIG. 1, the recording system 1 in the embodiment is provided with: the information recording apparatus 100; a communication network 200; and a distribution server 300.

The information recording apparatus 100 constitutes one example of the “information recording apparatus” of the present invention, and is operable to obtain (i.e. download) a content group 20, stored in a hard disk 301 provided for the distribution server 300, via the communication network 200, and to record it onto an optical disc 10, which constitutes one specific example of the “information recording medium” and the “second information recording medium” of the present invention. Incidentally, a plurality of information recording apparatuses 100 may be connected to the communication network 200.

The communication network 200 is a network for connecting the information recording apparatus 100 and the distribution server 300. The communication network 200 may be a leased line, public line or phone line, packet network, or line switching network. Moreover, the Internet may be adopted as the communication network 200. Moreover, the communication network 200 may be a wireless network, such as a mobile phone network, IMT-2000, PHS, or wireless LAN. Incidentally, the entire communication network 200 between the information recording apparatus 100 and the distribution server 300 does not have to be wired or wireless. One portion of the communication network 200 may be wired, and another portion of the communication network 200 may be wireless.

The distribution server 300 is provided with the hard disk 301 which constitutes one specific example of the “information recording medium” and the “first information recording medium” of the present invention. The distribution server 300 is connected to the information recording apparatus 100 via the communication network 200. The hard disk 301 provided for the distribution server 300 stores therein the content group 20 including one or more TV programs, movies or the like. The distribution server 300 distributes the content group 20 stored on the hard disk 301 to the information recording apparatus 100, in response to a request from the information recording apparatus 100.

As shown in FIG. 2, the information recording apparatus 100 is provided with; a disc drive 110 on which the optical disc 10 is actually loaded and on which the content group 20 is recorded; and a host computer 120, such as a personal computer, for controlling the recording of the content group 20 on the disc drive 110.

The disc drive 110 is provided with: the optical disc 10; a spindle motor 111; an optical pickup 112; a signal recording device 113; a CPU (drive control device) 114; a memory 115; a data input/output control device 116; and a bus 117. Moreover, the host computer 120 is provided with: a CPU 121; a memory 122; an operation/display control device 123; an operation button 124; a display panel 125; a data input/output control device 126; and a bus 127.

The spindle motor 111 is intended to rotate and stop the optical disc 10, and operates upon accessing the optical disc. More specifically, the spindle motor 111 is constructed to rotate the optical disc 10 at a predetermined speed and stop it, under spindle servo from a not-illustrated servo unit or the like.

The optical pickup 112 is to perform the recording/reproduction with respect to the optical disc 10, and is provided with a semiconductor laser device, a collimator lens, an objective lens, and the like. More specifically, the optical pickup 112 irradiates the optical disc 10 with a light beam, such as a laser beam, as reading light with a first power upon reproduction, and as writing light with a second power upon recording, with it modulated.

The signal recording device 113 constitutes one specific example of the “recording device” of the present invention. The signal recording device 113 controls the spindle motor 111 and the optical pickup 112 under the control of the CPU 114, to thereby perform the recording with respect to the optical disc 10. More specifically, the signal recording device 113 is provided with a laser diode (LD) driver, a head amplifier, and so on, for example. The LD driver generates, for example, a driving pulse and drives the semiconductor laser device located in the optical pickup 112. The head amplifier amplifies the output signal of the optical pickup 112, namely, the reflected light of a light beam, and outputs the amplified signal.

The CPU (drive control device) 114 is connected to the signal recording device 113 and the memory 115 via the bus 117, and controls the entire disc drive 110 by giving an instruction to various controlled devices. In general, software for operating the CPU 114 or firmware is stored in the memory 115.

The memory 115 is used in the general data processing on the disc drive 110, including a buffer area for the record data, an area used as an intermediate buffer when data is converted into the data that can be used on the signal recording device 113, and the like. Moreover, the memory 115 is provided with: a Read Only Memory (ROM) area into which a program for performing an operation as a recording device, namely, a firmware program is stored; and a Random Access Memory (RAM) area in which the record data is temporarily stored or in which a parameter required for the operation of a firmware program or the like is stored; and the like.

The data input/output control device 116 controls the input/output of the data from the exterior with respect to the disc drive 110. A drive control command, issued from the external host computer 120 which is connected with the disc drive 110 through an interface, such as a SCSI (Small Computer System Interface) and an ATAPI (AT Attachment Packet Interface), is transmitted to the CPU 114 through the data, input/output control device 116. Moreover, the record data is exchanged with the host computer 120 through the data input/output control device 116 in the same manner.

The operation/display control device 123 receives an operation instruction and performs display with respect to the host computer 120, and transmits various instructions by the operation button 124 (e.g. an instruction to start the recording and an instruction to stop the recording) to the CPU 121. The CPU 121 transmits a control command to the disc drive 110 through the data input/output control device 126 on the basis of instruction information from the operation/display control device 123 and controls the entire disc drive 110. In the same manner, the CPU 121 can transmit a command to request the transmission of an operation state to the host computer 120, with respect to the disc drive 110. By this, the operation state of the disc drive 110 (e.g. a recording execution state and a recording stopping state) can be recognized, so that the CPU 121 can output the operation state of the disc drive 110 to the display panel 125, such as a fluorescent tube and a LCD, through the operation/display control device 123.

Moreover, the data input/output control device 126 obtains the content group 20 obtained from the distribution server 300 via the communication network 200, and outputs the obtained content group 20 to the disc drive 110, under the control of the CPU 121.

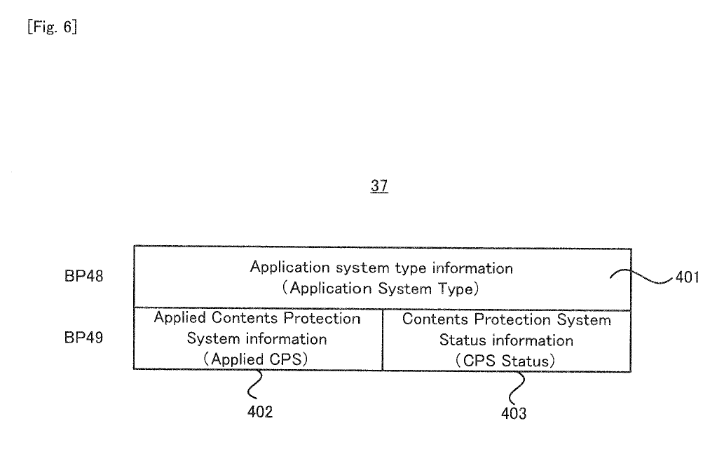

The CPU 121 controls the entire host computer 120. In particular, the CPU 121 is provided with: a control information obtainment/analysis device 128 for obtaining and analyzing control information (refer to FIG. 6, etc.) included in the content group 20 recorded on the hard disk 301 provided for the distribution server 300; and a file obtainment device 129 for controlling the data input/output control device 126 so as to obtain various files which constitute the content group 20, on the basis of the analysis result from the control information obtainment/analysis device 128. The content group 20 obtained by the control of the file obtainment device 129 on the basis of the analysis result from the control information obtainment/analysis device 128 is recorded onto the optical disc 10. Incidentally, the control information obtainment/analysis device 128 constitutes one specific example of the “first obtaining device” of the present invention, and the file obtainment device 129 constitutes one specific example of the “second obtaining device” of the present invention. The structure of the control information and the operations of the control information obtainment/analysis device 128 and the file obtainment device 129 will be discussed in more detail later.

The memory 122 is an internal storage apparatus used by the host computer 120. The memory 122 is provided with; ROM area into which a firmware program, such as a BIOS (Basic Input/Output System), is stored; a RAM area into which parameters required for an operating system and the operation of an application program or the like are stored; and the like.

(2) Data Structure

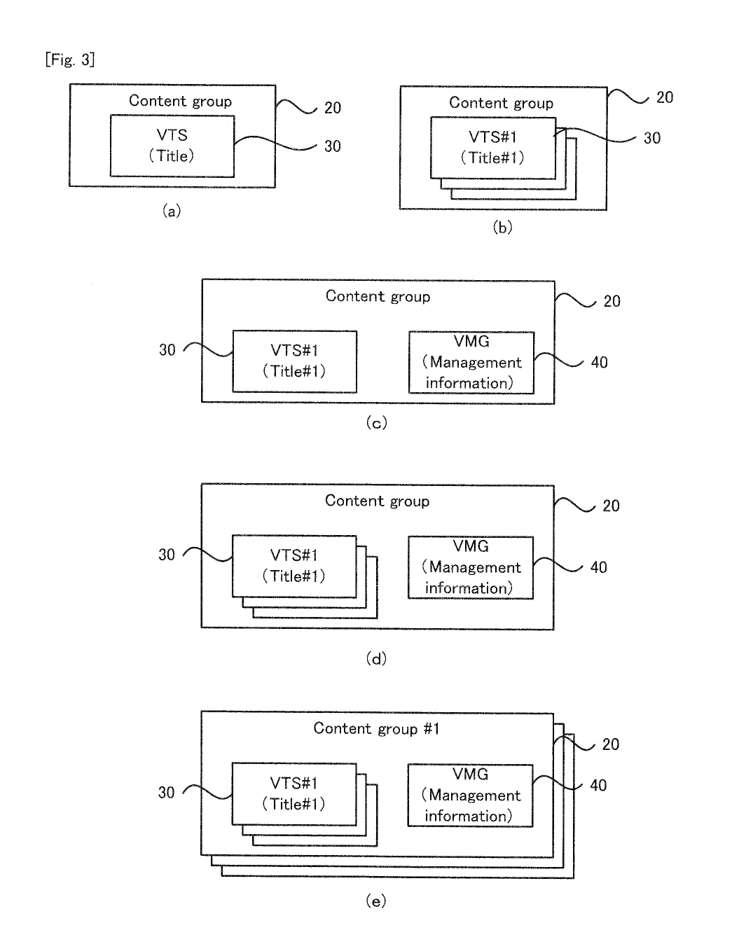

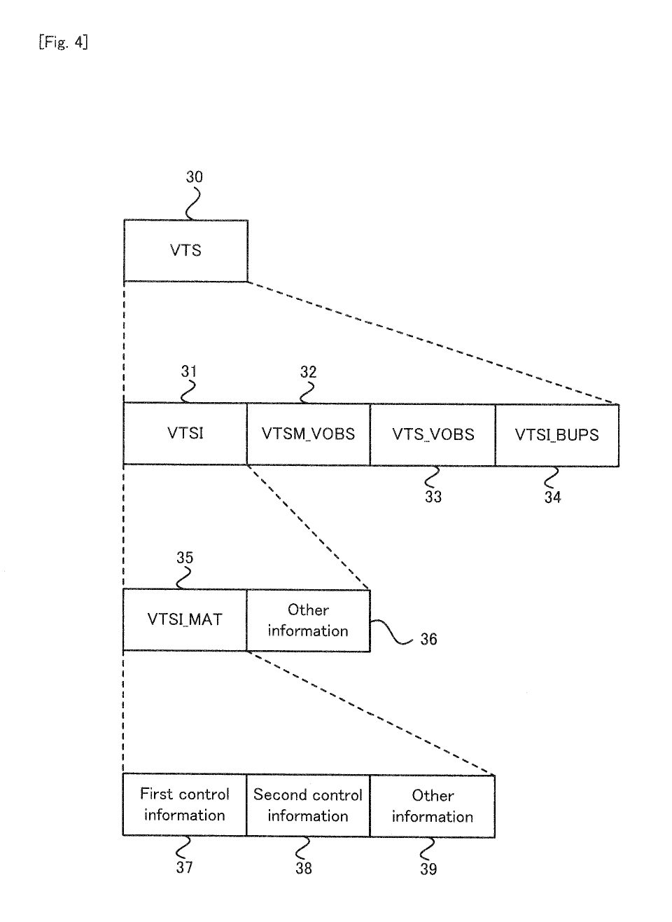

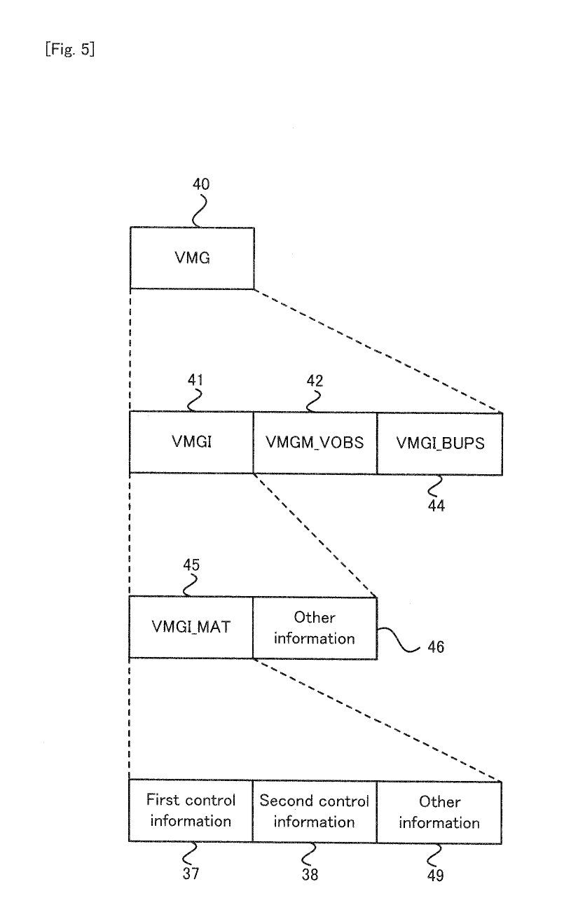

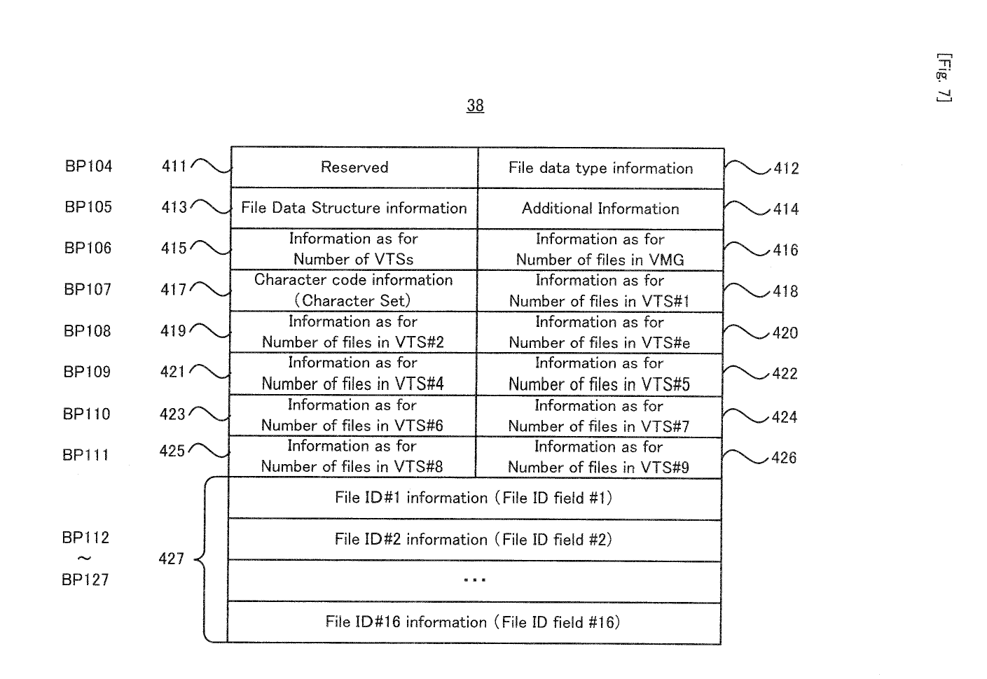

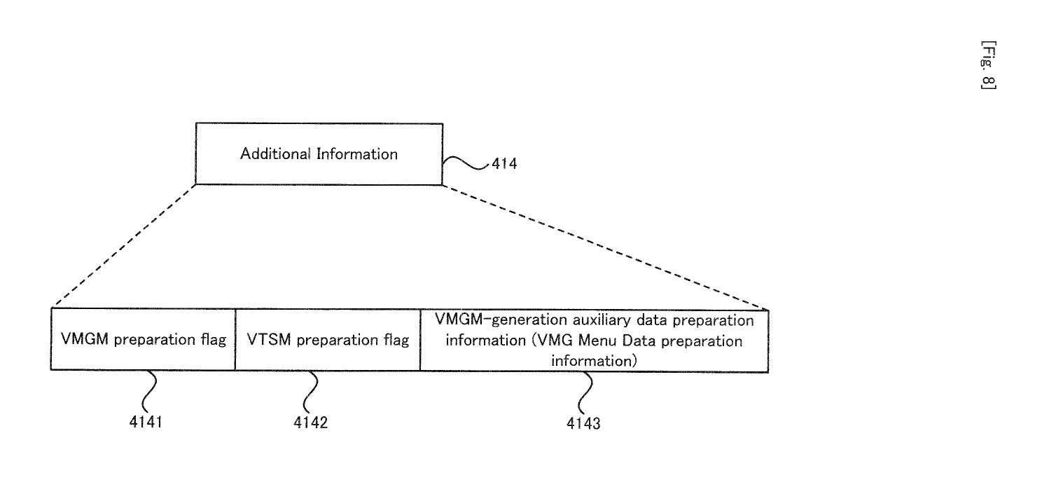

Next, with reference to FIG. 3 to FIG. 8, the specific data structure of the content group 20 will be explained. FIGS. 3(a), 3(b), 3(c), 3(d) and 3(e) are data structure diagrams conceptually showing the data structures of content groups 20. FIG. 4 is a data structure diagram conceptually showing the data structure of VTS 30 constituting the content group 20. FIG. 5 is a data structure diagram conceptually showing the data structure of VMG 40 constituting the content group 20. FIG. 6 is a data structure diagram conceptually showing the data structure of first control information 37 included in the VTS 30 and the VMG 40 constituting the content group. FIG. 7 is a data structure diagram conceptually showing the data structure of second control information 38 included in the VTS 30 and the VMG 40 constituting the content group. FIG. 8 is a data structure diagram conceptually showing the data structure of additional information 414 constituting the second control information 38.

Incidentally, the following explanation focuses a specific example in which the content group 20 is based on the DVD-Video standard. Therefore, the same structure as that of the DVD-Video standard will be omitted in its detailed explanation, in order to simplify the explanation. Moreover, the content group 20 is preferably compressed in accordance with, for example, MPEG (Moving Picture Expert Group).

As shown in FIG. 3(a), the content group 20 including one VTS (Video Title Set) 30 may be recorded in the hard disk 301. Incidentally, the VTS 30 constitutes one specific example of the “title information” of the present invention, and it is a set (group) of related titles (i.e. titles having the same number of audio information and sub-picture information, the same specification, and the same attribute such as corresponding language) in one movie or one TV program.

As shown in FIG. 3(b), the content group 20 including a plurality of VTSs 30 may be recorded in the hard disk 301.

As shown in FIG. 3(c), the content group 20 including one VTS 30 and one VMG (Video Manager) 40 may be recorded in the hard disk 301. Incidentally, the VMG 40 constitutes one specific example of the “management information” of the present invention, and it is information (e.g. data, a data list, a data file, or a data table, or a menu (hereinafter referred to as a “general menu”)) as for the entire VTS 30 managed by the VMG 40) for managing the VTS 30 included in the content group 20 together with the VMG 40.

As shown in FIG. 3(d), the content group 20 including a plurality of VTSs 30 and one VMG 40 may be recorded in the hard disk 301.

As shown in FIG. 3(e), a plurality of content groups 20 shown in FIG. 3(a) to FIG. 3(d) may be recorded in the hard disk 301.

As shown in FIG. 4, the VTS 30 includes: VTSI (VTS Information) 31; VTSM_VOBS (Video Object Set for the VTS Menu) 32; VTS_VOBS (Video Object Set for Titles in a VTS) 33; and VTSI_BUPS (VTSI Buck Up) 34. In the embodiment, if the content group 20 is recorded in the hard disk 301, the VTS 30 may not necessarily include the VTSM_VOBS 32 and the VTSI_BUPS34 out of the above. Moreover, in the embodiment, if the content group 20 is recorded on the optical disc 20, the VTS 30 may not necessarily include the VTSM_VOBS 32 out of the above.

The VTSI 31 is management information for managing the VTS 30, and is constructed by one file of “VTS_##_{—}0.1FO”. Incidentally, “##” is the identification number of the VTS, and an integer of 1 or more (wherein the upper limit is 99) is allocated in order, depending on the number of the VTSs 30 included in the content group 20.

The VTSM_VOBS 32 is data for various menus as for the VTS 30 (hereinafter, such a menu is referred to as a “title menu”, as occasion demands, as in the explanation described above), and it is constructed by one file of “VTS_##_{—}0.VOB”.

The VTS_VOBS 33 is entity information for actually reproducing the title, and is constructed by one or more files of “VTS_##_@.VOB”. Incidentally, “@” is a serial number depending on the number of the files, and an integer of 1 or more (wherein the upper limit is 9) is allocated in order, depending on the number of the files included in one VTS_VOBS 33.

The VTSI_BUPS 34 is the backup of the VTSI 31, and is constructed by one file of “VTS_##_{—}0.BUP”.

The VTSI 31 includes; VTSI_MAT (VTSI Main Table) 35; and other information 36.

The VTSI_MAT 35 includes: the first control information 37 and the second control information 38, which constitute one specific example of the “control information” of the present invention; and other information 39.

As shown in FIG. 5, the VMG 40 includes: VMGI (VMG Information) 41; VMGM_VOBS (Video Object Set for the VMG Menu) 42; and VMGI_BUPS (VMGI Buck Up) 44. In the embodiment, the VMG 40 may not necessarily include the VMGM_VOBS 42 and the VMGI_BUPS 44 out of the above.

The VMGI 41 is management information for managing the entire content group 20 including the VMG 40, and it is constructed by one file of “VIDEO_TS.IFO”.

The VMGM_VOBS 42 is data for various menus as for the entire content group 20 including the VMG 40 (e.g. a menu for selecting a desired title from a plurality of titles), and it is constructed by one file of “VIDEO_TS. VOB”.

The VMGI_BUPS 44 is the backup of the VMGI 41, and is constructed by one file of “VIDEO_TS. BUP”.

The VMGI 41 includes: VMGI_MAT (VMGI Main Table) 45; and other information 46.

The VMGI_MAT 45 includes: the first control information 37 and the second control information 38, which constitute one specific example of the “control information” of the present invention; and other information 49. Namely, the first control information 37 and the second control information 38 are redundantly recorded in each of the VMGI_MAT 45 and the VTSI_MAT 35. More specifically, the first control information 37 is recorded in byte positions (BP) 48 and BP 49 of the VMGI_MAT 45 and the VTSI_MAT 35. The second control information 38 is recorded in BP 104 to BP 127 of the VMGI_MAT 45 and the VTSI_MAT 35.

However, the first control information 37 and the second control information 38 may be recorded in at least one of the VMGI_MAT 45 and the VTSI_MAT 35. Or the first control information 37 and the second control information 38 may be recorded in different positions in the VMGI_MAT 45 and the VTSI_MAT 35. Moreover, even if the first control information 37 and the second control information 38 are recorded in each of the VMGI_MAT 45 and the VTSI_MAT 35, the above-mentioned byte positions are merely one specific example, and the first control information 37 and the second control information 38 may be recorded in other byte positions.

As shown in FIG. 6, the first control information 37 includes: application system type information 401; applied CPS (Contents Protection System) information 402; and CPS Status information 403.

The application system type information 401 indicates whether or not the content group 20 is the content group used in the recording operation described in the embodiment (namely, whether or not it is the content group obtained and recorded by using the first control information 37 and the second control information 38). The application system type information 401 occupies the entire byte position 48 of the VMGI_MAT 45 and the VTSI_MAT 35, having a size of 1 byte. For example, if the application system type information 401 indicates “11011100”, the information recording apparatus 100 can recognize that the content group 20 including the application system type information 401 is the content group for the recording operation described in the embodiment. Moreover, with respect to the content group used in another recording operation, a numerical value other than “11011100” is allocated to the application system type information 401. Moreover, the numerical value other than “11011100” may be left for the future extension, as reserved.

The applied CPS information 402 constitutes one specific example of the “encryption system information” of the present invention, and indicates an encryption system applied to the content group 20. The applied. CPS information 402 occupies 4 bits of the byte position 49 of the VMGI_MAT 45 and the VTSI_MAT 35. For example, if the applied CPS information 402 indicates “0100”, the information recording apparatus 100 can recognize that the encryption system applied to the content group 20 is CPRM. Of course, obviously, in addition to or instead of CPRM, for example, other encryption systems, such as CSS (Content Scrambling System), may be applied. In that case, the applied CPS information 402 indicates a numerical value other than “0100”. Moreover, the numerical value other than “0100” may be left for the future extension, as reserved.

The CPS Status information 403 constitutes one specific example of the “encryption information” of the present invention, and indicates whether or not the content group 20 is already encrypted. The CPS Status information 403 occupies 4 bits of the byte position 49 of the VMGI_MAT 45 and the VTSI_MAT 35. For example, if the CPS Status information 403 indicates “0100”, the information recording apparatus 100 can recognize that the content group 20 is not encrypted. In this case, the information recording apparatus 100 needs to perform the encryption process based on the encryption system indicated by the applied CPS information 402, on the content group 20, in recording the content group 20 onto the optical disc 10. On the other hand, if the CPS Status information indicates “1100”, the information recording apparatus 100 can recognize that the content group 20 is encrypted. Incidentally, a numerical value other than “0100” and “1100” may be left for the future extension, as reserved.

As shown in FIG. 7, the second control information 38 includes: file data type information 412; file data structure information 413; additional information 414; information 415 as for the number of VTSs; information 416 as for the number of files in VMG; character code information (Character Set) 417; information 418 as for the number of files in VTS#1; information 419 as for the number of files in VTS#2; information 420 as for the number of files in VTS#3; information 421 as for the number of files in VTS#4; information 422 as for the number of files in VTS#5; information 423 as for the number of files in VTS#6; information 424 as for the number of files in VTS#7; information 425 as for the number of files in VTS#8; information 426 as for the number of files in VTS#9; and file ID information 427.

The file data type information 412 constitutes one specific example of the “type information” of the present invention, and indicates whether or not the content group 20 is constructed by an authored (or authorized) disc data file on which authoring as DVD-Video disc images is performed. The file data type information 412 occupies 4 bits of the byte position 104 of the VMGI_MAT 45 and the VTSI_MAT 35. For example, if the file data type information 412 indicates “0100”, the information recording apparatus 100 can recognize that the content group 20 is constructed by the authored (or authorized) disc data file. Incidentally, a numerical value other than “0100” may be left for the future extension, as reserved.

The file data structure information 413 constitutes one specific example of the “structure information” of the present invention, and indicates whether the content group 20 (i) does not include the VMG 40 but includes the VTS 30 (i.e. is in the state shown in FIG. 3(a) and FIG. 3(b)), or (ii) includes the VMG 40 in addition to the VTS 30, as a disc full image (i.e. is in the states shown in FIG. 3(c) and FIG. 3(d)). The file data structure information 413 occupies 4 bits of the byte position 105 of the VMGI_MAT 45 and the VTSI_MAT 35. For example, if the file data structure information 413 indicates “0001”, the information recording apparatus 100 can recognize that the content group 20 does not include the VMG 40 but includes the VTS 30 (i.e. the VMG 40 is not distributed from the distribution server 300). On the other hand, if the file data structure information 413 indicates “0100”, the information recording apparatus 100 can recognize that the content group 20 includes the VMG 40 in addition to the VTS 30 (i.e. the content group 20 as the disc full image, including the VTS 30 and the VMG 40, is distributed from the distribution server 300). Incidentally, a numerical value other than “0001” and “0100” may be left for the future extension, as reserved.

The additional information 414, as shown in FIG. 8, includes: VMGM preparation flag 4141; VTSM preparation flag 4142; and VMGM-generation auxiliary data preparation information (VMG Menu Data preparation information) 4143.

The VMGM preparation flag 4141 constitutes one specific example of the “general menu flag” of the present invention, and indicates whether or not the content group 20 includes the VMGM_VOBS 42 (i.e. the above-mentioned file of “VIDEO_TS.VOB”). The VMGM preparation flag 4141 occupies 1 bit of the byte position 105 of the VMGI_MAT 45 and the VTSI_MAT 35. For example, if the VMGM preparation flag 4141 indicates “0”, the information recording apparatus 100 can recognize that the content group 20 does not include the VMGM_VOBS 42. As the case where the VMGM preparation flag 4141 indicates “0”, there are possibly the case where the file data structure information 413 indicates “0001” (i.e. where the content group 20 does not include the VMG 40), and the case where the file data structure information 413 indicates “0100” but the content group 20 does not include the VMGM_VOB 42. On the other hand, if the VMGM preparation flag 4141 indicates “1”, the information recording apparatus 100 can recognize that the content group 20 includes the VMGM_VOBS 42. Namely, as the case where the VMGM preparation flag 4141 indicates “1”, there are possibly the case where the file data structure information 413 indicates “0100” and the content group 20 includes the VMGM_VOBS 42.

The VTSM preparation flag 4142 constitutes one specific example of the “title menu flag” of the present invention, and indicates whether or not the content group 20 includes the VTSM_VOBS 32 (i.e. the above-mentioned file of “VTS_##_{—}0.VOB”). The VTSM preparation flag 4142 occupies 1 bit of the byte position 105 of the VMGI_MAT 45 and the VTSI_MAT 35. For example, if the VTSM preparation flag 4142 indicates “0”, the information recording apparatus 100 can recognize that the content group 20 does not include the VTSM_VOBS 32. On the other hand, if the VTSM preparation flag 4142 indicates “1”, the information recording apparatus 100 can recognize that the content group 20 includes the VTSM_VOBS 32.

The VMGM-generation auxiliary data preparation information 4143 constitutes one specific example of the “menu preparation information” of the present invention, and indicates whether or not the content group 20 includes data for generating the VMGM_VOBS42 (i.e. data for generating the general menu). The VMGM-generation auxiliary data preparation information 4143 occupies 2 bits of the byte position 105 of the VMGI_MAT 45 and the VTSI_MAT 35. For example, if the VMGM-generation auxiliary data preparation information 4143 indicates “00”, the information recording apparatus 100 can recognize that the content group 20 does not include the data for generating the VMGM_VOBS42. Incidentally, if the file data structure information 413 indicates “0100”, the content group 20 already includes the VMG 40, so that the VMGM-generation auxiliary data preparation information 4143 indicates “00”. For example, if the VMGM-generation auxiliary data preparation information 4143 indicates “01”, the information recording apparatus 100 can recognize that the content group 20 includes the data for generating the VMGM_VOBS42 and that the data is thumbnail image data. As a result, the information recording apparatus 100 can generate the VMGM_VOBS 42 by using the thumbnail image data. For example, if the VMGM-generation auxiliary data preparation information 4143 indicates “10”, the information recording apparatus 100 can recognize that the content group 20 includes the data for generating the VMGM_VOBS 42 and that the data is still image data for each screen (in other words, page by page). As a result, the information recording apparatus 100 can generate the VMGM_VOBS 42 by using the still image data. Incidentally, if the VMGM-generation auxiliary data preparation information 4143 indicates “01” or “10”, the file data structure information 413 indicates “0001”. Moreover, a numerical value other than “00”, “01”, and “10” may be left for the future extension, as reserved.

In FIG. 7 again, the information 415 as for the number of VTSs, constitutes one specific example of the “title number information” of the present invention, and indicates the number of the VTSs 30 included in the content group 20. The information 415 as for the number of VTSs, occupies 4 bits of the byte position 106 of the VMGI_MAT 45 and the VTSI_MAT 35.

Incidentally, in the embodiment, one content group 20 includes up to nine VTSs 30. However, it may be constructed such that one content group 20 includes ten or more VTSs 30.

The information 416 as for the number of files in VMG, constitutes one specific example of the “management file number information” of the present invention, and indicates the number of files in the VMG 40 included in the content group 20. The information 416 as for the number of files in VMG, occupies 4 bits of the byte position 106 of the VMGI_MAT 45 and the VTSI_MAT 35.

Incidentally, in the embodiment, the VMG 40 can include one VMGI 41, one VMGM_VOBS 42, and one VMGI_BUPS 44. Namely, in the embodiment, one VMG 40 can include up to three files.

Moreover, the above-mentioned file data structure information 413 enables the recognition of whether or not the content group 20 includes the VMG 40, but the information 416 as for the number of files in VMG, also allows the recognition of whether or not the content group 20 includes the VMG 40. Namely, if the information 416 as for the number of files in VMG indicates “0”, it can be recognized that the content group 20 does not include the VMG 40. On the other hand, if the information 416 as for the number of files in VMG indicates “a numerical value other than 0”, it can be recognized that the content group 20 includes the VMG 40.

The character code information 417 constitutes one specific example of the “code information” of the present invention, and indicates a character code for describing the file ID information 427. The_character code information 417 occupies 4 bits of the byte position 107 of the VMGI_MAT 45 and the VTSI_MAT 35. For example, if character code information 417 indicates “0001”, the information recording apparatus 100 can recognize that the character code for describing the file ID information 427 is an ASCII code. Incidentally, a numerical value other than “0001” may be left for the future extension, as reserved.

The information 418 as for the number of files in VTS#1, constitutes one specific example of the “title file number information” of the present invention, and indicates the number of files in the VTS#1 included in the content group 20. The information 418 as for the number of files in VTS#1, occupies 4 bits of the byte position 107 of the VMGI_MAT 45 and the VTSI_MAT 35.

Incidentally, in the embodiment, the VTS 30 can include one VTSI 31, one VTSM_VOBS 32, up to nine VTS_VOBSs 33, and one VTSI_BUPS 34. Namely, in the embodiment, one VTS 30 can include up to twelve files.

The information 419 as for the number of files in VTS#2, constitutes one specific example of the “title file number information” of the present invention, and indicates the number of files in the VTS#2 included in the content group 20. The information 419 as for the number of files in VTS#2, occupies 4 bits of the byte position 108 of the VMGI_MAT 45 and the VTSI_MAT 35.

The information 420 as for the number of files in VTS#3, constitutes one specific example of the “title file number information” of the present invention, and indicates the number of files in the VTS#3 included in the content group 20. The information 420 as for the number of files in VTS#3, occupies 4 bits of the byte position 108 of the VMGI_MAT 45 and the VTSI_MAT 35.

The information 421 as for the number of files in VTS#4, constitutes one specific example of the “title file number information” of the present invention, and indicates the number of files in the VTS#4 included in the content group 20. The information 421 as for the number of files in VTS#4, occupies 4 bits of the byte position 109 of the VMGI_MAT 45 and the VTSI_MAT 35.

The information 422 as for the number of files in VTS#5, constitutes one specific example of the “title file number information” of the present invention, and indicates the number of files in the VTS#5 included in the content group 20. The information 422 as for the number of files in VTS#5, occupies 4 bits of the byte position 109 of the VMGI_MAT 45 and the VTSI_MAT 35.

The information 423 as for the number of files in VTS#6, constitutes one specific example of the “title file number information” of the present invention, and indicates the number of files in the VTS#6 included in the content group 20. The information 423 as for the number of files in VTS#6, occupies 4 bits of the byte position 110 of the VMGI_MAT 45 and the VTSI_MAT 35.

The information 424 as for the number of files in VTS#7, constitutes one specific example of the “title file number information” of the present invention, and indicates the number of files in the VTS#7 included in the content group 20. The information 424 as for the number of files in VTS#7, occupies 4 bits of the byte position 110 of the VMGI_MAT 45 and the VTSI_MAT 35.

The information 425 as for the number of files in VTS#8, constitutes one specific example of the “title file number information” of the present invention, and indicates the number of files in the VTS#8 included in the content group 20. The information 425 as for the number of files in VTS#8, occupies 4 bits of the byte position 111 of the VMGI_MAT 45 and the VTSI_MAT 35.

The information 426 as for the number of files in VTS#9, constitutes one specific example of the “title file number information” of the present invention, and indicates the number of files in the VTS#9 included in the content group 20. The information 426 as for the number of files in VTS#9, occupies 4 bits of the byte position 111 of the VMGI_MAT 45 and the VTSI_MAT 35.

Incidentally, in the embodiment, one content group 20 includes up to nine VTSs 30 and at least one VTS 30. Therefore, depending on the number of the VTSs 30 included in the content group 20, the information is used in order, starting from the information 418 as for the number of files in VTS#1. At this time, a numerical value (e.g. “0000”) indicating that there is no corresponding VTS 30 is written into the information as for the number of files in VTS#j (wherein j is an integer of 2 or more) which is not used. Moreover, if it is constructed to include 10 or more VTSs 30 in one content group 20, the information as for the number of files in VTS#j is preferably extended, depending on the number of the VTSs 30.

The file ID #y information 427 (wherein y is an integer, 1≦y≦16) constitutes one specific example of the “identifier” of the present invention, and indicates a file name for identifying the content group 20. The file ID #y information 427 occupies the byte position 112 to the byte position 127 of the VMGI_MAT 45 and the VTSI_MAT 35, and has a data size of 16 bytes. Since each of the file ID #y information 427 has a size of 1 byte, each of the file ID #y information 427 indicates one character or letter. Therefore, the file ID #y information 427 can show the file name up to 16 characters or letters, as a whole.

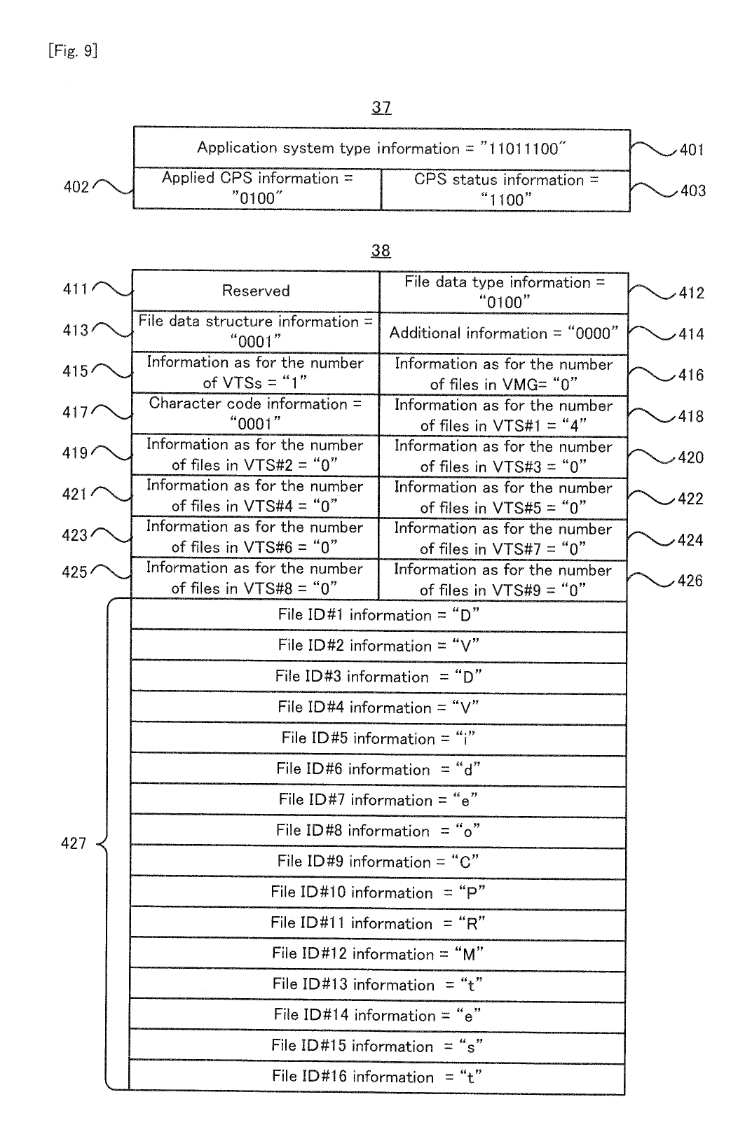

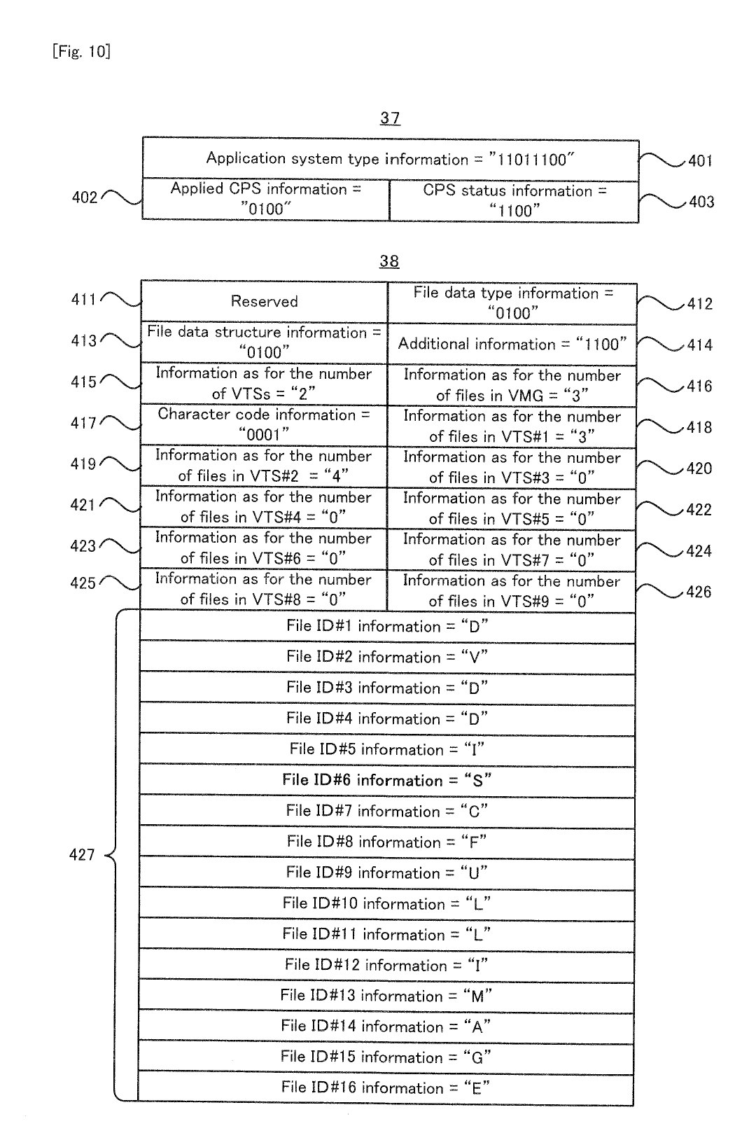

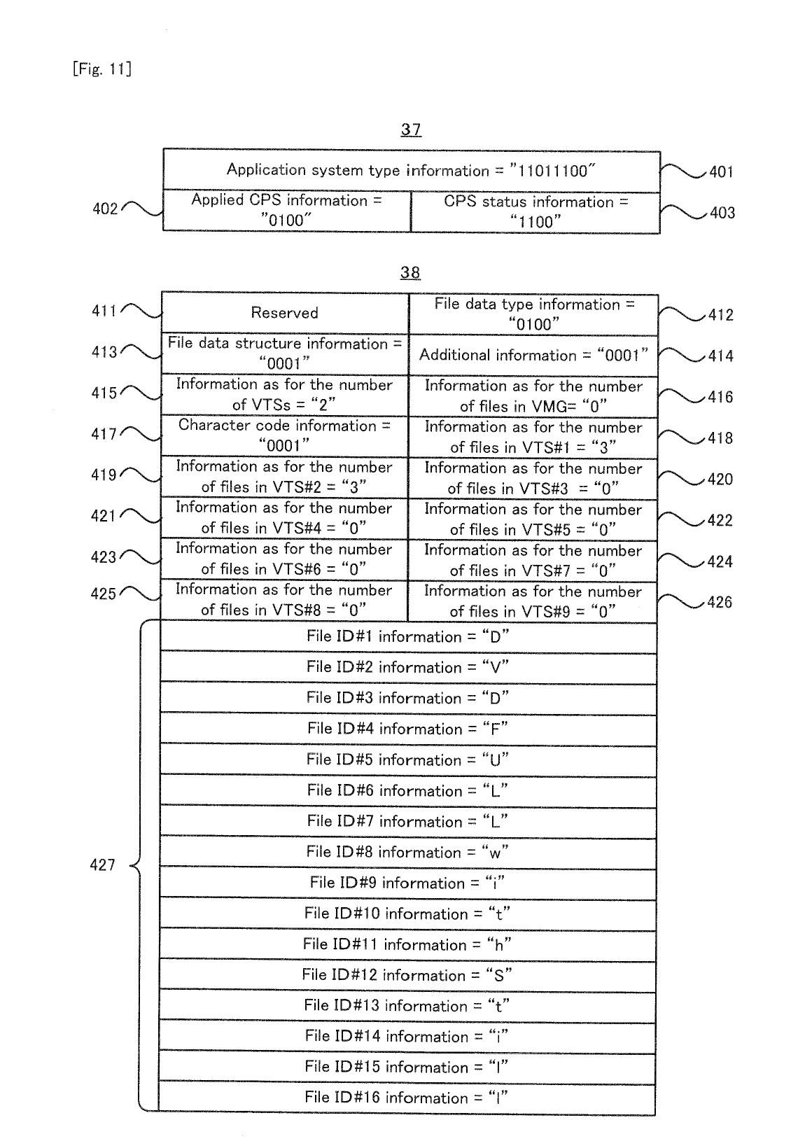

Next, with reference to FIG. 9 to FIG. 11, an explanation will be given for the specific data structure of the first control information 37 and the second control information 38 in the specific content group 20 using the data structures explained in FIG. 3 to FIG. 8. FIG. 9 is a data structure diagram conceptually showing a specific first data structure of the first control information 37 and the second control information 38 in the specific content group 20 using the data structures explained in FIG. 3 to FIG. 8. FIG. 10 is a data structure diagram conceptually showing a specific second data structure of the first control information 37 and the second control information 38 in the specific content group 20 using the data structures explained in FIG. 3 to FIG. 8. FIG. 11 is a data structure diagram conceptually showing a specific third data structure of the first control information 37 and the second control information 38 in the specific content group 20 using the data structures explained in FIG. 3 to FIG. 8.

FIG. 9 shows the data structure of the first control information 37 and the second control information 38 in the content group 20 in which the file data structure information 413 indicates “0001”, the number of the VTSs 30 is 1, the number of files constituting the VTS_VOBS 33 is 2, the VTSI_BUPS 34 is included, and a file name is “DVDVideoCPRMTest”.

As shown in FIG. 9, in the first control information 37, the application system type information 401 is “11011100”, the applied CPS information 402 is “0100”, and the CPS Status information 403 is “1100”. Therefore, the information recording apparatus 100 can recognize that the content group 20 is the content group used for the recording operation described in the embodiment, that the encryption method of the content group 20 is CPRM, and that the content group 20 is already encrypted, with reference to the first control information 37.

Moreover, in the second control information 38, the file data type information 412 is “0100”, the file data structure information 413 is “0001”, the additional information 414 is “0000”, the information 415 as for the number of VTSs is “1”, the information 416 as for the number of files in VMG is “0”, the character code information 417 is “0001”, the information 418 as for the number of files in VTS#1 is “4”, the information 419 as for the number of files in VTS#2 to the information 426 as for the number of files in VTS#9 are “0”, and the file name is “DVDVideoCPRMTest”. Therefore, the information recording apparatus 100 can recognize that the content group 20 is authorized as the DVD-Video disc image, that the content group 20 does not include the VMG 40, that the content group 20 does not include the VMGM_VOBS 42 nor the VTSM_VOBS 32, that the content group 20 does not include the data for generating the VMGM_VOBS 42, that the number of the VTSs 30 included in the content group 20 is 1, that the file name of the content group 20 is written by the ASCII code, that the number of files in the VTS#1 is 4, and that the file name of the content group 20 is “DVDVideoCPRMTest”.

At this time, the content group 20 includes “DVDVideoCPRMTestVTS_{—}01_{—}0.IFO”, “DVDVideoCPRMTestVTS_{—}01_{—}0.BUP”, “DVDVideoCPRMTestVTS_{—}01_{—}1.VOB”, and “DVDVideoCPRMTestVTS_{—}01_{—}2.VOB”. Namely, the file name written by the file ID#y information 427 in the second control information 38 is combined with the file names of files constituting the VTS 30 explained with reference to FIG. 4.

The information recording apparatus 100 uses the file extensions and the file names in order to judge whether or not the VTS 30 includes the VTSM_VOBS 32 and the VTSI_BUPS 34. In the example shown in FIG. 9, there is a file whose extension is “BUP”, so that the information recording apparatus 100 can recognize that the VTS 30 includes the VTSI_BUPS 34. On the other hand, there is no file whose extension is “VOB” and whose file name includes “VTS_##_{—}0”, so that the information recording apparatus 100 can recognize that the VTS 30 does not include the VTSM_VOBS 32. However, whether or not the VTS 30 includes the VTSM_VOBS 32 may be recognized by referring to the VTSM preparation flag 4142 in the additional information 414. Moreover, the VTS 30 definitely includes the VTSI 31 (namely, a file with an extension of “IFO”).

Therefore, if the information recording apparatus 100 can recognize whether or not the VTS 30 includes the VTSM_VOBS 32 and the VTSI_BUPS 34 by referring to the extensions and the file names of the files included in the content group 20 (or by referring to the VTSM preparation flag 4142), the information recording apparatus 100 can recognize the number of files constituting the VTS_VOBS 33 included in the VTS 30, from the information 418 as for the number of files in VTS#1. In the example shown in FIG. 9, the information recording apparatus 100 can recognize that the number of files constituting the VTS_VOBS 33 is two. By this, the information recording apparatus 100 can preferably recognize what kind of file is included in the content group 20. In other words, the information recording apparatus 100 can preferably recognize the file included in the content group 20 is what kind of files.

Moreover, in the example shown in FIG. 9, the content group 20 does not include the VMG 40. Therefore, the information recording apparatus 100 preferably refer to the first control information 37 and the second control information 38 recorded in the VTSI_MAT 35.

Moreover, in the example shown in FIG. 9, an explanation will be given for a case where the additional information 414 is not “0000” but “0001”; namely, a case where the content group 20 includes the thumbnail image data for generating the VMGM_VOBS 42. In this case, the file name of a file indicating the thumbnail image data is defined as, for example, “DVDVideoCPRMTestVTS_{—}01_S.STL”. Thus, if the additional information 414 is “0001”, the information recording apparatus 100 preferably obtains the thumbnail image data expressed by the file name of “DVDVideoCPRMTestVTS_{—}01_S.STL”, and generates the VMGM_VOBS 42 from the thumbnail image data. Of course, it is obviously possible to use another file name.

Moreover, if the content group 20 includes a plurality of VTSs 30, one VTS 30 preferably corresponds to one thumbnail image data. Thus, one VTS 30 is preferably constructed to include one title (i.e. one movie, one TV program, etc.). Moreover, the file name of the thumbnail image data is preferably expressed by “DVDVideoCPRMTestVTS_##_S.STL”, depending on the number of the VTSs 30. Here, “##” is the identification number of the VTS, and an integer of 1 or more (wherein the upper limit is 99) is allocated in order, depending on the number of the VTSs 30 included in the content group 20.

It may be also constructed such that one VTS 30 includes a plurality of titles. In this case, the thumbnail image data may be prepared for each title, or collectively prepared for VTS 30. In any case, it is preferable to give the file name by which the file indicating the thumbnail image data can be individually identified.

Moreover, in the example shown in FIG. 9, an explanation will be given for a case where the additional information 414 is not “0000” but “0010”; namely, a case where the content group 20 includes the still image data for each screen for generating the VMGM_VOBS 42. In this case, the file name of a file indicating the still image data is defined as, for example, “DVDVideoCPRMTestVTS_{—}01_P.STL”. Thus, if the additional information 414 is “0010”, the information recording apparatus 100 preferably obtains the still image data expressed by the file name of “DVDVideoCPRMTestVTS_{—}01_P.STL”, and generates the VMGM_VOBS 42 from the still image data. Of course, it is obviously possible to use another file name.

Moreover, if the content group 20 includes a plurality of VTSs 30, one VTS 30 preferably corresponds to one still image data. Thus, one VTS 30 is preferably constructed to include one title (i.e. one movie, one TV program, etc.). Moreover, the file name of the still image data is preferably expressed by “DVDVideoCPRMTestVTS_##_P.STL”, depending on the number of the VTSs 30. Here, “##” is the identification number of the VTS, and an integer of 1 or more (wherein the upper limit is 99) is allocated in order, depending on the number of the VTSs 30 included in the content group 20.

FIG. 10 shows the data structure of the first control information 37 and the second control information 38 in the content group 20 in which the file data structure information 413 indicates “0100”, the number of the VTSs 30 is 2, the VMGM_VOBS 42 is included, the VTSM_VOBS 32 is included, and a file name is “DVDDISCFULLIMAGE”.

As shown in FIG. 10, in the first control information 37, the application system type information 401 is “11011100”, the applied CPS information 402 is “0100”, and the CPS Status information 403 is “1100”. Therefore, the information recording apparatus 100 can recognize that the content group 20 is the content group used for the recording operation described in the embodiment, that the encryption method of the content group 20 is CPRM, and that the content group 20 is already encrypted, with reference to the first control information 37.

Moreover, in the second control information 38, the file data type information 412 is “0100”, the file data structure information 413 is “0100”, the additional information 414 is “1100”, the information 415 as for the number of VTSs is “2”, the information 416 as for the number of files in VMG is “3”, the character code information 417 is “0001”, the information 418 as for the number of files in VTS#1 is “3”, the information 419 as for the number of files in VTS#2 is “4”, the information 420 as for the number of files in VTS#3 to the information 426 as for the number of files in VTS#9 are “0”, and the file name is “DVDDISCFULLIMAGE”. Therefore, the information recording apparatus 100 can recognize that the content group 20 is authorized as the DVD-Video disc image, that the content group 20 includes the VMG 40, that the content group 20 includes the VMGM_VOBS 42 and the VTSM_VOBS 32, that the content group 20 does not include the data for generating the VMGM_VOBS 42, that the number of the VTSs 30 included in the content group 20 is 2, that the file name of the content group 20 is written by the ASCII code, that the number of files in the VTS#1 is 3, that the number of files in the VTS#2 is 4, and that the file name of the content group 20 is “DVDDISCFULLIMAGE”.

At this time, the content group 20 includes, as the VMG 40, “DVDDISCFULLIMAGEVIDEO_TS.IFO”, “DVDDISCFULLIMAGEVIDEO_TS.VOB”, and “DVDDISCFULLIMAGEVIDEO_TS.BUP”. Moreover, the content group 20 includes, as the VTS#1, “DVDDISCFULLIMAGEVTS_{—}01_{—}0.IFO”, “DVDDISCFULLIMAGEVTS_{—}01_{—}0.VOB”, and “DVDDISCFULLIMAGEVTS_{—}01_{—}1.VOB”. Moreover, the content group 20 includes, as the VTS#2, “DVDDISCFULLIMAGEVTS_{—}02_{—}0.IFO”, “DVDDISCFULLIMAGEVTS_{—}02_{—}0.VOB”, “DVDDISCFULLIMAGEVTS_{—}02_{—}1.VOB”, and “DVDDISCFULLIMAGEVTS_{—}02_{—}2.VOB”.

Even in this case, the information recording apparatus 100 identifies the above-mentioned files in the same manner as explained in FIG. 9. Even with regard to the VMG 40, the information recording apparatus 100 identifies the above-mentioned files in the same operation as in the case of the VTS 30. Namely, with regard to each of the VTS 30 and the VMG 40, by referring to the file extensions and the file names, the information 416 as for the number of files in VMG, the information 418 as for the number of files in VTS#1, and the information 419 as for the number of files in VTS#2 (furthermore, referring to the VMGM preparation flag 4141 and the VTSM preparation flag 4142), the information recording apparatus 100 can preferably recognize what kind of file is included in the content group 20. In other words, the information recording apparatus 100 can preferably recognize the file included in the content group 20 is what kind of files.

Moreover, in the example shown in FIG. 10, the content group 20 includes the VMG 40. Therefore, the information recording apparatus 100 may refer to the first control information 37 and the second control information 38 recorded in the VTSI_MAT 35, or the first control information 37 and the second control information 38 recorded in the VMGI_MAT 45.

Incidentally, in the example shown in FIG. 10, both the VTS#1 and the VTS#2 do not include the BUP file (i.e. the file with the extension of BUP). In this case, the information recording apparatus 100 only need to copy “DVDDISCFULLIMAGEVTS_{—}01_{—}0.IFO” and “DVDDISCFULLIMAGEVTS_{—}02_{—}0.IFO”, and record them onto the optical disc 10 as “DVDDISCFULLIMAGEVTS_{—}01_{—}0.BUP” and “DVDDISCFULLIMAGEVTS_{—}02_{—}0.BUP”, respectively.

FIG. 11 shows the data structure of the first control information 37 and the second control information 38 in the content group 20 in which the file data structure information 413 indicates “0001”, the number of the VTSs 30 is 2, the VMG 40 is not included, the data for generating the VMGM_VOBS 42 is included, and a file name is “VTSFULLwithStill”.

As shown in FIG. 11, in the first control information 37, the application system type information 401 is “11011100”, the applied CPS information 402 is “0100”, and the CPS Status information 403 is “1100”. Therefore, the information recording apparatus 100 can recognize that the content group 20 is the content group used for the recording operation described in the embodiment, that the encryption method of the content group 20 is CPRM, and that the content group 20 is already encrypted, with reference to the first control information 37.

Moreover, in the second control information 38, the file data type information 412 is “0100”, the file data structure information 413 is “0001”, the additional information 414 is “0001”, the information 415 as for the number of VTSs is “2”, the information 416 as for the number of files in VMG is “0”, the character code information 417 is “0001”, the information 418 as for the number of files in VTS#1 is “3”, the information 419 as for the number of files in VTS#2 is “3”, the information 420 as for the number of files in VTS#3 to the information 426 as for the number of files in VTS#9 are “0”, and the file name is “VTSFULLwithStill”. Therefore, the information recording apparatus 100 can recognize that the content group 20 is authorized as the DVD-Video disc image, that the content group 20 does not include the VMG 40, that the content group 20 does not include the VMGM_VOBS 42 and the VTSM_VOBS 32, that the content group 20 includes the thumbnail image data for generating the VMGM_VOBS 42, that the number of the VTSs 30 included in the content group 20 is 2, that the file name of the content group 20 is written by the ASCII code, that the number of files in the VTS#1 is 3, that the number of files in the VTS#2 is 3, and that the file name of the content group 20 is “VTSFULLwithStill”.

At this time, the content group 20 includes, as the VTS#1, “VTSFULLwithStillVTS_{—}01_{—}0.IFO”, “VTSFULLwithStillVTS_{—}01_{—}0.BUP”, and “VTSFULLwithStillVTS_{—}01_{—}1.VOB”. Moreover, the content group 20 includes, as the VTS#2, “VTSFULLwithStillVTS_{—}02_{—}0.IFO”, “VTSFULLwithStillVTS_{—}02_{—}0.BUP”, and “VTSFULLwithStillVTS_{—}02_{—}1.VOB”. Moreover, the content group 20 includes, as the thumbnail image data for generating the VMGM_VOB42, “VTSFULLwithStillVTS_{—}01_S.STL” for the VTS#1, and “VTSFULLwithStilIVTS_{—}02_S.STL” for the VTS#2.

Even in this case, with regard to each of the VTS 30 and the VMG 40, by referring to the file extensions and the file names, the information 416 as for the number of files in VMG, the information 418 as for the number of files in VTS#1, the information 419 as for the number of files in VTS#2, and furthermore, the additional information 414 or the like, the information recording apparatus 100 can preferably recognize what kind of file is included in the content group 20. In other words, the information recording apparatus 100 can preferably recognize the file included in the content group 20 is what kind of files.

Incidentally, in the above-mentioned explanation, an explanation was given for the aspect that the first control information 37 and the second control information 38 are recorded into both of the VTSI_MAT 35 and the VMGI_MAT 45. However, it may be constructed to record the first control information 37 and the second control information 38 into another position other than the VTSI_MAT 35 and the VMGI_MAT 45. Alternatively, aside from the VTS 30 and the VMG 40, which constitute the content group 20, the first control information 37 and the second control information 38 may be recorded in the hard disk 301, as one independent file expressed by a file name of, for example, “***.MNG (wherein “***” is preferably a file name indicated by the second control information 38)”. No matter how the first control information 37 and the second control information 38 are recorded, as long as the first control information 37 and the second control information 38 are associated with the content group 20, the information recording apparatus 100 can obtain the content group 20 from the distribution server 300 with reference to the first control information 37 and the second control information 38, and record the content group 20 onto the optical disc 10.

Moreover, in recording the content group 20 onto the optical disc 10, it may be constructed such that the information recording apparatus 100 records the content group 20 including both the first control information 37 and the second control information 38, onto the optical disc 10. At this time, both the first control information 37 and the second control information 38 may be recorded in both of the VTSI_MAT 35 and the VMGI_MAT 45, or may be recorded in one of the VTSI_MAT 35 and the VMGI_MAT 45, or may be recorded in another position other than the VTSI_MAT 35 and the VMGI_MAT 45. Alternatively, the first control information 37 and the second control information 38 may be recorded on the optical disc 10, as one independent file expressed by a file name of, for example, “***.MNG”. Alternatively, in recording the content group 20 onto the optical disc 10, it may be constructed such that the information recording apparatus 100 records the content group 20 which does not include both the first control information 37 and the second control information 38, onto the optical disc 10.

(3) Operation Principle

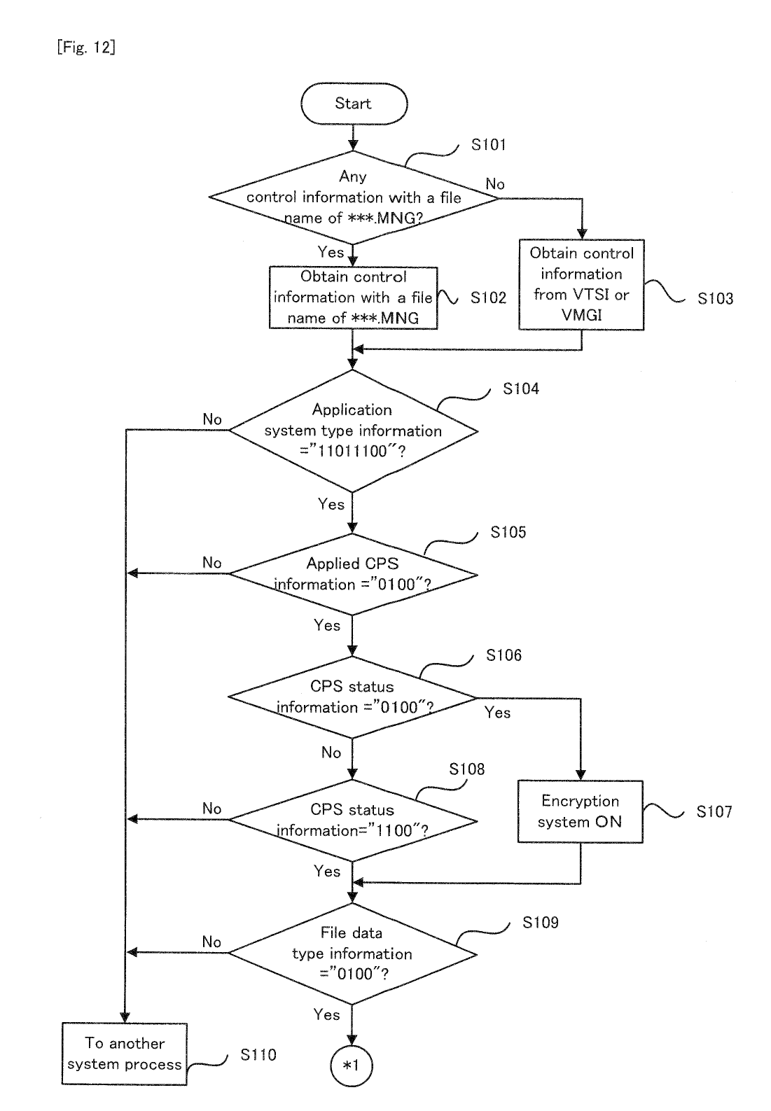

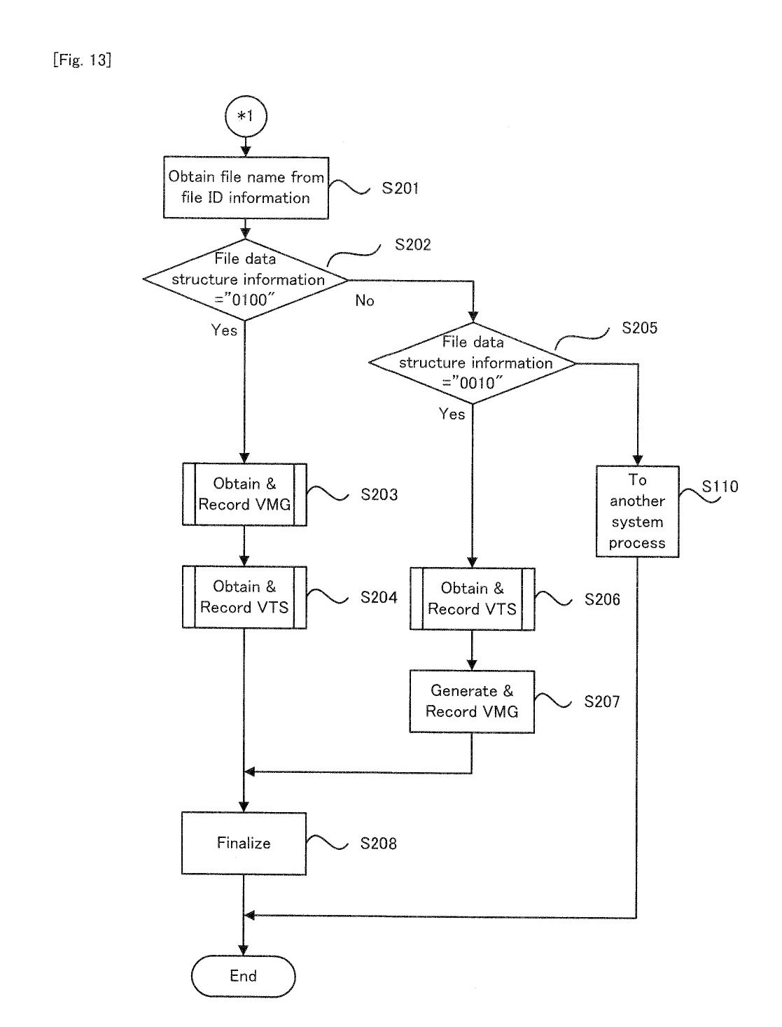

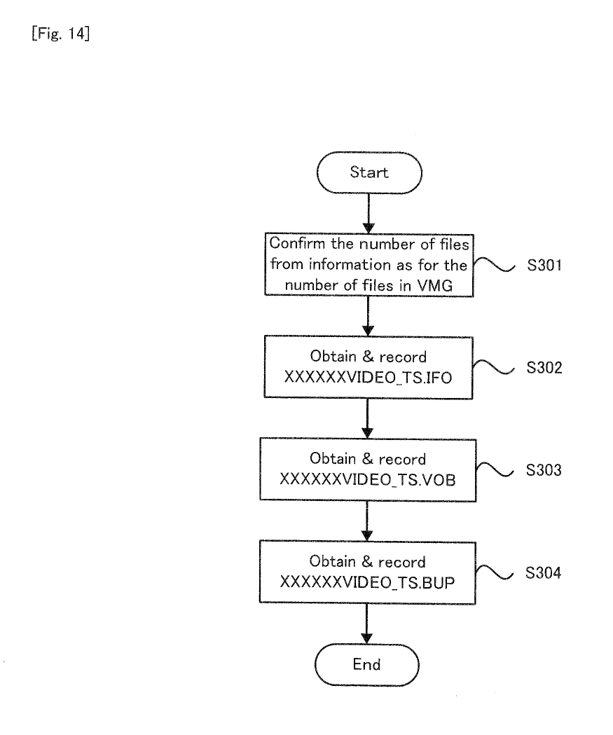

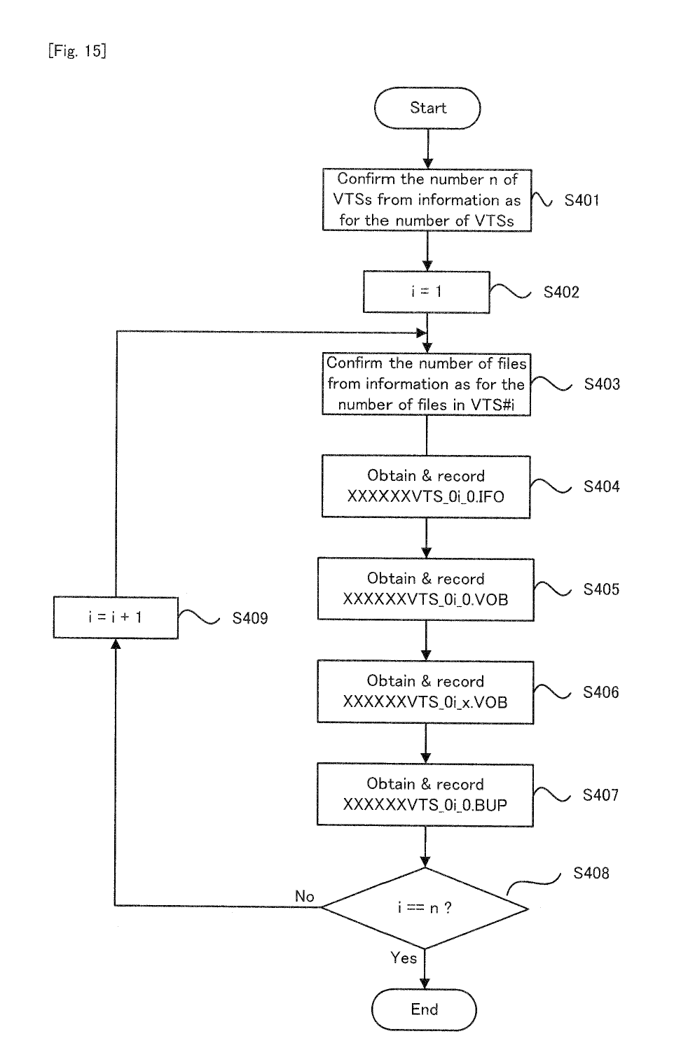

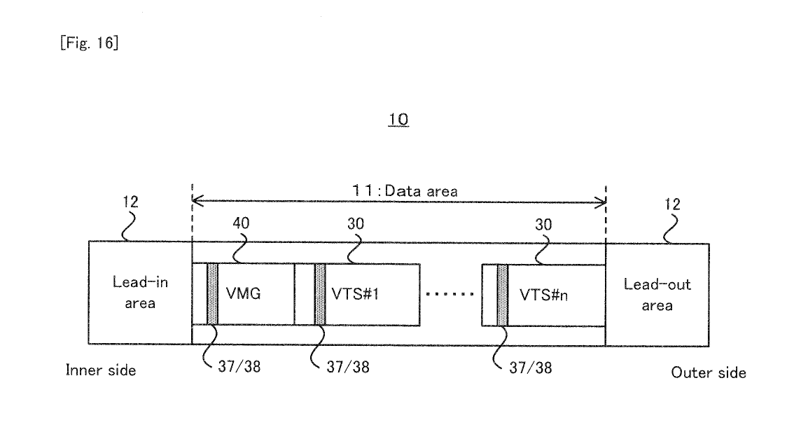

Next, with reference to FIG. 12 to FIG. 16, an explanation will be given for the recording operation of the recording system 1 in the embodiment. Namely, an explanation will be given for the operation when the information recording apparatus 100 obtains the content group 20 recorded on the hard disk 301 provided for the distribution server 300, via the communication network 200, and records the content group 20 onto the optical disc 10. FIG. 12 is a flowchart conceptually showing a first flow of the recording operation of the recording system 1 in the embodiment. FIG. 13 is a flowchart conceptually showing a second flow of the recording operation of the recording system 1 in the embodiment. FIG. 14 is a flowchart conceptually showing a third flow of the recording operation of the recording system 1 in the embodiment. FIG. 15 is a flowchart conceptually showing a fourth flow of the recording operation of the recording system 1 in the embodiment. FIG. 16 is an explanatory diagram conceptually showing the area structure of the optical disc 10 on which the content group 20 is recorded.

As shown in FIG. 12, the information recording apparatus 100 judges whether or not the control information expressed by a file name of “***. MNG” corresponding to the desired content group 20 (in other words, the content group 20 whose obtainment is desired) is recorded on the hard disk 301 of the distribution server 300, under the control of the control information obtainment/analysis device 128 (step S101). Namely, the information recording apparatus 100 judges whether or not the one independent file obtained by combining the first control information 37 and the second control information 38 is recorded in the hard disk 301. Hereinafter, the first control information 37 and the second control information 38 are collectively referred to as the “control information”.

As a result of the judgment in the step S101, if it is judged that the control information expressed by the file name of “***. MNG” is recorded (the step S101: Yes), the control information is obtained under the control of the information obtainment/analysis device 128 (step S102).

On the other hand, as a result of the judgment in the step S101, if it is judged that the control information expressed by the file name of “***. MNG” is not recorded (the step S101: No), the control information is obtained from at least one of the VTSI_MAT 35 and the VMGI_MAT 45 under the control of the information obtainment/analysis device 128 (step S103). More specifically, such information that is recorded in the byte positions 48, 49, and 104 to 127 of at least one of a file of “XXXXXXVIDEO_TS.IFO (wherein XXXXXX is a file name)” and a file of “XXXXXXVTS_##_{—}0.IFO” is obtained.

Then, under the control of the information obtainment/analysis device 128, it is judged whether or not the application system type information 401 included in the control information obtained in the step S102 or the step S103 indicates “11011100” (step S104).

As a result of the judgment in the step S104, if it is judged that the application system type information 401 does not indicate “11011100” (the step S104: No), another system process different from the recording operation in the embodiment is performed (step S110).

On the other hand, as a result of the judgment in the step S104, if it is judged that the application system type information 401 indicates “11011100” (the step S104: Yes), then, under the control of the information obtainment/analysis device 128, it is judged whether or not the applied CPS information 402 included in the control information obtained in the step S102 or the step S103 indicates “0100” (step S105).

As a result of the judgment in the step S105, if it is judged that the applied CPS information 402 does not indicate “0100” (the step S105: No), another system process different from the recording operation in the embodiment is performed (the step S110).

On the other hand, as a result of the judgment in the step S105, if it is judged that the applied CPS information 402 indicates “0100” (the step S105: Yes), then, under the control of the information obtainment/analysis device 128, it is judged whether or not the CPS Status information 403 included in the control information obtained in the step S102 or the step S103 indicates “0100” (step S106).

As a result of the judgment in the step S106, if it is judged that the CPS Status information 403 indicates “0100” (the step S106: Yes), the encryption system (in other words, encryption processing circuit) of the information recording apparatus 100 is changed to ON (step S107). Namely, the information recording apparatus 100 performs the encryption process based on the encryption system (CPRM in the embodiment) indicated by the applied CPS information 402 when recording the content group 20 onto the optical disc 10. Then, the operational flow goes to a step S109.

On the other hand, as a result of the judgment in the step S106, if it is judged that the CPS Status information 403 does not indicate “0100” (the step S106: No), then, under the control of the information obtainment/analysis device 128, it is judged whether or not the CPS Status information 403 included in the control information obtained in the step S102 or the step S103 indicates “1100” (step S108).

As a result of the judgment in the step S108, if it is judged that the CPS Status information 403 does not indicate “1100” (the step S108: No), another system process different from the recording operation in the embodiment is performed (the step S110).

On the other hand, as a result of the judgment in the step S108, if it is judged that the CPS Status information 403 indicates “1100” (the step S108: Yes), the information recording apparatus 100 can recognize that the content group 20 obtained from the distribution server 300 is already encrypted in accordance with the encryption system (CPRM in the embodiment) indicated by the applied CPS information. Therefore, the information recording apparatus 100 does not have to perform the encryption process based on the encryption system (CPRM in the embodiment) indicated by the applied CPS information 402 when recording the content group 20 onto the optical disc 10, and can record the obtained content group 20 onto the optical disc 10 as it is. Then, the operational flow goes to the step S109.

Then, under the control of the information obtainment/analysis device 128, it is judged whether or not the file data type information 412 included in the control information obtained in the step S102 or the step S103 indicates “0100” (step S109).

As a result of the judgment in the step S109, if it is judged that the file data type information 412 does not indicate “0100” (the step S109: No), another system process different from the recording operation in the embodiment is performed (the step S110).

On the other hand, as a result of the judgment in the step S109, if it is judged that the file data type information 412 indicates “0100” (the step S109: Yes), the operational flow goes to a step S201 in FIG. 13.

Then, as shown in FIG. 13, under the control of the information obtainment/analysis device 128, the file name is obtained from the file ID #y information 427 included in the control information obtained in the step S102 or the step S103 in FIG. 12 (step S201).

Then, under the control of the information obtainment/analysis device 128, it is judged whether or not the file data structure information 413 included in the control information obtained in the step S102 or the step S103 in FIG. 12 indicates “0100” (step S202),

As a result of the judgment in the step S202, if it is judged that the file data structure information 413 indicates “0100” (the step S202: Yes), the information recording apparatus 100 can recognize that the content group 20 includes the VMG 40. Therefore, under the control of the file obtainment device 129 responding to the analysis result of the control information, the VMG 40 constituting the content group 20 is obtained from the distribution server 300, and recorded onto the optical disc 10 (step S203). Incidentally, the operations of obtaining and recording the VMG 40 will be described in detail later, using FIG. 14. Then, under the control of the file obtainment device 129 responding to the analysis result of the control information, the VTS 30 constituting the content group 20 is obtained from the distribution server 300, and recorded onto the optical disc 10 (step S204). Incidentally, the operations of obtaining and recording the VTS 30 will be described in detail later, using FIG. 15.

Moreover, if the file data structure information 413 indicates “0100”, the content group 20 is authorized as the disc full image including the VMG 40. Therefore, the information recording apparatus 100 automatically performs a finalize process on the optical disc 10, under the control of the CPU 121, which constitutes one specific example of the “finalizing device” of the present invention, after the recording of the VMG 40 and the VTS 30 (step S208). After that, the recording operation is ended.

On the other hand, as a result of the judgment in the step S202, if it is judged that the file data structure information 413 does not indicate “0100” (the step S202: No), then, under the control of the information obtainment/analysis device 128, it is judged whether or not the file data structure information 413 included in the control information obtained in the step S102 or the step S103 in FIG. 12 indicates “0010” (step S205).

As a result of the judgment in the step S205, if it is judged that the file data structure information 413 does not indicate “0010” (the step S205: No), another system process different from the recording operation in the embodiment is performed (the step S110).

On the other hand, as a result of the judgment in the step S205, if it is judged that the file data structure information 413 indicates “0010” (the step S205: Yes), the information recording apparatus 100 can recognize that the content group 20 does not include the VMG 40 but includes only the VTS 30. Therefore, under the control of the file obtainment device 129 responding to the analysis result of the control information, the VTS 30 constituting the content group 20 is obtained from the distribution server 300, and recorded onto the optical disc 10 (step S206).

Then, under the control of the CPU 121, which constitutes one specific example of the “generating device” of the present invention, the VMG 40 is generated (step S207). Here, the VMG 40 is generated on the basis of the content of the VTS 30 recorded in the step S206 or the control information included in the VTS 30 recorded in the step S206. The generated VMG 40 is recorded onto the optical disc 10. Then, the finalize process is performed (the step S208), and the recording operation is ended.

Next, an explanation will be given for the operations of obtaining and recording the VMG 40 in the step S203 in FIG. 13. As shown in FIG. 14, firstly, under the control of the information obtainment/analysis device 128, the number of files constituting the VMG 40 is obtained by referring to the information 416 as for the number of files in VMG included in the control information obtained in the step S102 or the step S103 in FIG. 12 (step S301).

Then, under the control of the file obtainment device 129, “XXXXXXVIDEO_TS.IFO (wherein XXXXXX is a file name)” (i.e. the VMGI 41) is obtained by referring to the file name and extension, and recorded onto the optical disc 10 (step S302).

Then, under the control of the file obtainment device 129, if it is recognized that the content group 20 includes “XXXXXXVIDEO_TS.VOB” (i.e. the VMGM_VOBS 42) by referring to the file name and extension (moreover, the VMGM preparation flag 4141, etc.), then the file is obtained and recorded onto the optical disc 10 (step S303).

At this time, if the content group 20 does not include “XXXXXXVIDEO_TS.VOB” but includes the data for generating the VMGM_VOBS 42, it may be constructed to use the data to generate “XXXXXXVIDEO_TS.VOB”, under the control of the CPU 121. Alternatively, even if the content group 20 does not include “XXXXXXVIDEO_TS.VOB” nor the data for generating the VMGM_VOBS 42, it may be constructed such that the information recording apparatus 100 independently generates “XXXXXXVIDEO_TS.VOB”. The generated “XXXXXXVIDEO_TS.VOB” is recorded onto the optical disc 10.

Then, under the control of the file obtainment device 129, if it is recognized that the content group 20 includes “XXXXXXVIDEO_TS.BUP” (i.e. the VMGI_BUPS 44) by referring to the file name and extension, then the file is obtained and recorded onto the optical disc 10 (step S304).

At this time, if the content does not include “XXXXXXVIDEO_TS.BUP”, the copy of “XXXXXXVIDEO_TS.IFO” obtained in the step S302 is preferably recorded onto the optical disc 10, as “XXXXXXVIDEO_TS.BUP”.

Next, an explanation will be given for the operations of obtaining and recording the VTS 30 in the step S204 or the step S206 in FIG. 13. As shown in FIG. 15, firstly, under the control of the information obtainment/analysis device 128, the number of the VTSs 30 included in the content group 20 is obtained by referring to the information 415 as for the number of VTSs included in the control information obtained in the step S102 or the step S103 in FIG. 12 (step S401). Here, it is assumed that the number of VTSs is “n”.

Then, a variable “i” is initialized to “1” (step S402).

Then, under the control of the information obtainment/analysis device 128, the number of files constituting VTS#i 30 is obtained by referring to the information as for the number of files in VTS#i (the information 418 to 426) included in the control information obtained in the step S102 or the step S103 in FIG. 12 (step S403).

Then, under the control of the file obtainment device 129, “XXXXXXVTS_{—}0i_{—}0.IFO (i.e. the VTSI 31) is obtained by referring to the file name and extension, and recorded onto the optical disc 10 (step S404).

Then, under the control of the file obtainment device 129, if it is recognized that the content group 20 includes “XXXXXXVTS_{—}0i_{—}0.VOB” (i.e. the VTSM_VOBS 32) by referring to the file name and extension (moreover, the VTSM preparation flag 4142, etc.), then the file is obtained and recorded onto the optical disc 10 (step S405).

At this time, even if the content group 20 does not include “XXXXXXVTS_{—}0i_{—}0.VOB”, it may be constructed such that the information recording apparatus 100 independently generates “XXXXXXVTS_{—}0i_{—}0.VOB”. The generated “XXXXXXVTS_{—}0i_{—}0.VOB” is recorded onto the optical disc 10.

Then, under the control of the file obtainment device 129, “XXXXXXVTS_{—}0i_x.VOB (wherein x is a serial number depending on the number of VOB files included in the VTS#i” (i.e. the VTS_VOBS 33) is obtained by referring to the file name and extension, and recorded onto the optical disc 10 (step S406).

Then, under the control of the file obtainment device 129, if it is recognized that the content group 20 includes “XXXXXXVTS_{—}0i_{—}0.BUP” (i.e. the VTSI_BUPS 34) by referring to the file name and extension, then the file is obtained and recorded onto the optical disc 10 (step S407).

At this time, if the content does not include “XXXXXXVTS_{—}0i_{—}0.BUP”, the copy of “XXXXXXVTS_{—}0i_{—}0.IFO” obtained in the step S404 is preferably recorded onto the optical disc 10, as “XXXXXXVTS_{—}0i_{—}0.BUP”.

Then, under the control of the CPU 121, it is judged whether or not the variable “i” is equal to the number “n” of the VTSs 30 (step S408).

As a result of the judgment in the step S408, if it is judged that the variable “i” is not equal to the number “n” of the VTSs 30 (the step S408: No), it is possible to judge that the process in the step S403 to the step S407 is not performed on all the VTSs 30 included in the content group 20. In other words, it is possible to judge that all the VTSs 30 included in the content group 20 are not obtained nor recorded. Therefore, after the variable “i” is incremented by 1 (step S409), the operations from the step S403 to the step S408 are repeated again.

On the other hand, as a result of the judgment in the step S408, if it is judged that the variable “i” is equal to the number “n” of the VTSs 30 (the step S408: Yes), it is possible to judge that the process in the step S403 to the step S407 is performed on all the VTSs 30 included in the content group 20. In other words, it is possible to judge that all the VTSs 30 included in the content group 20 are obtained and recorded. Therefore, the recording operation of recording the VTS 30 is ended.

As explained above, according to the recording system 1 in the embodiment, the information recording apparatus 100 can recognize the file structure of the content group 20 recorded on the hard disk 301 provided for the distribution server 300, relatively easily and certainly, by referring to the first control information 37 and the second control information 38. Namely, the information recording apparatus 100 can preferably recognize the file structure of the desired content group 20 from among many files recorded on the hard disk 301. Moreover, the information recording apparatus 100 can preferably recognize what kind of file is included in the desired content group 20.

More specifically, the information recording apparatus 100 can judge whether or not the desired content group 20 corresponds to the above-mentioned data structure and recording operation, by referring to the application system type information 401 included in the first control information 37. This allows the information recording apparatus 100 to preferably perform the above-mentioned recording operation if the desired content group 20 corresponds to the above-mentioned data structure and recording operation.

Moreover, the information recording apparatus 100 can recognize the encryption of the content group 20, by referring to the applied CPS information 402 and the CPS Status information 403 included in the first control information 37. This allows the information recording apparatus 100 to preferably encrypt the content group 20.

Moreover, the information recording apparatus 100 can preferably recognize the format of the content group 20, by referring to the file data type information 412 included in the second control information 38. This allows the information recording apparatus 100 to preferably obtain and record the content group 20 in the format corresponding to the information recording apparatus 100.

Moreover, the information recording apparatus 100 can preferably recognize whether or not the content group 20 includes the VMG 40, by referring to the file data structure information 413 (moreover, the information 416 as for the number of files in VMG) included in the second control information 38. This allows the information recording apparatus 100 to automatically perform the finalize process after recording the content group 20 onto the optical disc 10, if the content group 20 includes the VMG 40.

Moreover, the information recording apparatus 100 can preferably recognize the file names of files constituting the content group 20, by referring to the character code information 417 and the file ID information 427 included in the second control information 38. In addition, the information recording apparatus 100 can preferably recognize the files included in the VMG 40 constituting the content group 20, by referring to the information 416 as for the number of files in VMG and the VMGM preparation flag 4141 included in the second control information 38. In addition, the information recording apparatus 100 can preferably recognize the files included in the VTS 30 constituting the content group 20 for each VTS 30, by referring to the information 415 as for the number of VTSs, the VTSM preparation flag 4142, and the information as for the number of files in VTS (the information 418 to 426) included in the second control information 38. This allows the information recording apparatus 100 to obtain and record the files constituting the desired content group 20, preferably and certainly.

Moreover, the information recording apparatus 100 can judge whether or not the content group 20 includes the data for generating the VMGM_VOBS 42, relatively easily, by referring to the VMGM-generation auxiliary data preparation information 4143 included in the second control information 38. This allows the information recording apparatus 100 to use the relevant data to preferably generate the VMGM_VOBS 42 if there is the data for generating the VMGM_VOBS 42.

As described above, according to the embodiment, the information recording apparatus 100 can preferably obtain the desired content group 20 and further preferably record the content group 20 onto the optical disc 10.

Incidentally, FIG. 16 shows the area structure of the optical disc 10 on which the content group 20 is recorded. As shown in FIG. 16, the VMG 40 and the VTS 30 are recorded into a data area 11 located between a lead-in area 12 and a lead-out area 13 provided for the optical disc 10. Then, in one portion of the VTS 30 and the VMG 40, the first control information 37 and the second control information 38 are recorded. Thus, the data area 11 constitutes one specific example of the “content group recording area” of the present invention, and one portion of the data area 11 constitutes one specific example of the “control information recording area” of the present invention. Of course, even in the case where the content group 20 is recorded on the hard disk 301, in the same manner, the area portion in which the VTS 30 and the VMG 40 are recorded constitutes one specific example of the “content group recording area” of the present invention, and one portion of the area portion in which the VTS 30 and the VMG 40 are recorded constitutes one specific example of the “control information recording area” of the present invention.

In addition, if it is constructed to record the first control information 37 and the second control information 38 onto the optical disc 10, it can be relatively easily judged whether or not the content group 20 is accurately obtained and recorded, by comparing them with the first control information 37 and the second control information 38 recorded on the hard disk 301 provided for the distribution server 300.

In addition, even if a plurality of VTSs 30 are separately obtained from a plurality of content groups 20 and recorded onto the optical disc 10, since the VTSI_MAT 35 includes the first control information 37 and the second control information 38, it is possible to relatively easily generate the VMG 40 regarding the plurality of VTSs 30 separately obtained from the plurality of content groups 20, by referring to the first control information 37 and the second control information 38.

Moreover, each of the first control information 37 and the second control information 38 is referred to in recording the content group 20 onto the optical disc 10. On the other hand, they are not referred to in reproducing the content group 20 recorded on the optical disc 10. Thus, even if the content group 20 includes the first control information 37 and the second control information 38, that has no or little adverse effect on the reproduction of the content group 20.

Moreover, according to the embodiment, the first control information 37 and the second control information 38 can be recorded into the same byte position of each of the VTSI_MAT 35 and the VMGI_MAT 45. Thus, it is possible to equalize the method of referring to the first control information 37 and the second control information 38 recorded in the VTSI_MAT 35, with the method of referring to the first control information 37 and the second control information 38 recorded in the VMGI_MAT 45. This leads to a load reduction in the operation of the information recording apparatus 100.

Incidentally, in the above-mentioned embodiment, the file extension indicating the VTSI 31 and the VMGI 41 is “IFO”, the file extension indicating the VTSM_VOBS 32, the VTS_VOBS 33, and the VMGM_VOBS 42 is “VOB”, and the file extension indicating the VTSI_BUPS 34 and the VMGI_BUPS 44 is “BUP”. However, it may be also constructed to specially define the extensions of the files constituting the content group 20 obtained via the communication network 200, to thereby distinguish them from the files constituting the content group 20 sold as the packaged software already authorized. For example, with regard to the files constituting the content group 20 obtained via the communication network 200, the file extension indicating the VTSI 31 and the VMGI 41 may be defined as “IDC”, the file extension indicating the VTSM_VOBS 32, the VTS_VOBS 33, and the VMGM_VOBS 42 may be defined as “VDC”, and the file extension indicating the VTSI_BUPS 34 and the VMGI_BUPS 44 may be defined as “BDC”. Then, it may be also constructed such that the first control information 37 and the second control information 38 are effectively treated if the file extensions are “IDC”, “VDC”, and “BDC”, and that the first control information 37 and the second control information 38 are not effectively treated (in other words, not referred to) if the file extensions are “IFO”, “VOB”, and “BUP”.

Moreover, the above-mentioned recording system 1 may be applied to a system having a structure other than that of the distribution system for obtaining the content group 20 via the communication network 200. For example, it may be applied to such a system that the information recording apparatus 100 performs the operation of obtaining the content group 20 from a certain recording source by using some devices. Even in this case, the above-mentioned various benefits can be received.

Incidentally, in the above-mentioned embodiment, the optical disc 10 and the hard disk 301 are explained as one example of the information recording medium, and the recorder related to the optical disc 10 is explained as one example of the information recording apparatus. The present invention, however, is not limited to the optical disc and the recorder thereof, and can be applied to other various high-density-recording or high-transmission-rate information recording media, and the recorders thereof.

The present invention is not limited to the above-described embodiment, and various changes may be made, if desired, without departing from the essence or spirit of the invention which can be read from the claims and the entire specification. An information recording medium, an information recording apparatus, an information recording method and a computer program, which involve such changes, are also intended to be within the technical scope of the present invention.

1. An information recording medium, comprising:
a content recording area to record therein a content group including one or a plurality of title information; and
a control information recording area to record therein control information including (i) type information indicating whether or not the content group is authorized as an image file based on a predetermined format, and (ii) structure information indicating whether or not the content group includes management information for managing the content group, in addition to the one or plurality of title information.

2. The information recording medium according to claim 1, wherein the control information includes title number information indicating the total number of the title information included in the content group.

3. The information recording medium according to claim 1, wherein the control information includes title file number information indicating the total number of files included in each of the one or plurality of title information.

4. The information recording medium according to claim 1, wherein the control information includes an identifier for identifying the content group.

5. The information recording medium according to claim 4, wherein the control information includes code information indicating a character code of the identifier.

6. The information recording medium according to claim 1, wherein the control information includes management file number information indicating the total number of files included in the management information.

7. The information recording medium according to claim 1, wherein the control information includes menu preparation information indicating whether or not the content group includes menu generation information, which is to generate general menu information as for the entire content group, in addition to the one or plurality of title information.

8. The information recording medium according to claim 1, wherein the control information includes a general menu flag indicating whether or not the content group includes general menu information as for the entire content group, in addition to the one or plurality of title information.

9. The information recording medium according to claim 1, wherein the control information includes a title menu flag indicating whether or not the content group includes title menu information as for at least one of the one or plurality of title information, in addition to the one or plurality of title information.

10. The information recording medium according to claim 1, wherein the control information includes encryption information indicating whether or not the content group is encrypted.

11. The information recording medium according to claim 10, wherein the control information includes encryption system information indicating an encryption system of the content group.

12. The information recording medium according to claim 1, wherein the information recording medium comprises a plurality of control information recording areas.

13. The information recording medium according to claim 1, wherein the control information recording area is disposed in the content recording area.

14. An information recording apparatus for recording a content group onto a second information recording medium from a first information recording medium recording thereon: the content group including one or a plurality of title information; and control information including (i) type information indicating whether or not the content group is authorized as an image file based on a predetermined format, and (ii) structure information indicating whether or not the content group includes management information for managing the content group, in addition to the one or plurality of title information, said information recording apparatus comprising:
a first obtaining device for obtaining the control information recorded on the first information recording medium;
a second obtaining device for obtaining the content group from the first information recording medium, on the basis of the obtained control information; and a recording device for recording the obtained content group onto the second information recording medium.

15. The information recording apparatus according to claim 14, wherein said recording device records the obtained control information onto the second information recording medium.

16. The information recording apparatus according to claim 14, wherein the control information includes title number information indicating the total number of the title information included in the content group, and title file number information indicating the total number of files included in each of the one or plurality of title information, and said second obtaining device obtains the predetermined number of files corresponding to the title number information and the title file number information, as the content group.

17. The information recording apparatus according to claim 14, wherein the control information includes an identifier for identifying the content group, and said second obtaining device obtains the content group identified by the identifier.

18. The information recording apparatus according to claim 14, wherein the control information includes management file number information indicating the total number of files included in the management information, and said second obtaining device obtains the predetermined number of files corresponding to the management file number information, as the content group.

19. The information recording apparatus according to claim 14, further comprising a finalizing device for performing a finalize process on the second information recording medium after the recording of the content group by said recording device, if the content group is authorized as the image file and the content group includes the management information.

20. The information recording apparatus according to claim 14, further comprising:
a generating device for generating the management information corresponding to the obtained content group after the recording of the content group by said recording device, if the content group does not include the management information; and a finalizing device for performing a finalize process on the second information recording medium after the management information is generated.

21. The information recording apparatus according to claim 14, wherein said recording device records the obtained control information into a plurality of positions on the second information recording medium.

22. An information recording method of recording a content group onto a second information recording medium from a first information recording medium recording thereon: the content group including one or a plurality of title information; and control information including (i) type information indicating whether or not the content group is authorized as an image file based on a predetermined format, and (ii) structure information indicating whether or not the content group includes management information for managing the content group, in addition to the one or plurality of title information, said information recording method comprising:
a first obtaining process of obtaining the control information recorded on the first information recording medium; a second obtaining process of obtaining the content group from the first information recording medium, on the basis of the obtained control information; and a recording process of recording the obtained content group onto the second information recording medium.

23. A computer program product in a computer-readable medium for tangibly embodying a program of instructions executable by a computer provided in the information recording apparatus according to claim 14, to make the computer function as at least one of said first obtaining device, said second obtaining device, and said recording device.
